(19) United States
(12) Patent Application Publication
(10) Pub. No.: US 2026/0084433 A1
(43) Pub. Date: Mar. 26, 2026

(54) PRINTING ELEMENT SUBSTRATE, LIQUID EJECTION HEAD, AND LIQUID EJECTION APPARATUS

(71) Applicant: CANON KABUSHIKI KAISHA, Tokyo (JP)

(72) Inventors: KENJI FUKADA, Tokyo (JP); TOSHIO NEGISHI, Kanagawa (JP)

(21) Appl. No.: 19/341,795

(22) Filed: Sep. 26, 2025

(30) Foreign Application Priority Data
Sep. 26, 2024 (JP) 2024-167592

(51) Int. Cl. B41J 2/20; B41J 2/14; B41J 2/175; B41J 2/18

(52) U.S. Cl. CPC B41J 2/20; B41J 2/14201; B41J 2/175; B41J 2/18; B41J 2002/14491

(57) ABSTRACT

An object of the present disclosure is to provide a printing element substrate on which printing elements, circulation elements, and wiring lines are arranged efficiently. The printing element substrate includes a first unit including a first element and a second element, a second unit including a third element and a fourth element, and a power supply wiring line including a first portion and a second portion. The power supply wiring line includes an extension portion that extends along a boundary line between the first unit and the second unit. The first element and the third element are arranged symmetrically with respect to the extension portion. The second element and the fourth element are arranged symmetrically with respect to the extension portion. The first portion and the second portion are arranged symmetrically with respect to the extension portion.

### BACKGROUND

### Field of the Technology

The present disclosure relates to a printing element substrate, a liquid ejection head, and a liquid ejection apparatus.

### Description of the Related Art

In general, a liquid ejection apparatus that ejects liquids to perform printing includes a liquid ejection head that ejects the liquids. The liquid ejection head includes a printing element substrate that includes energy-generating elements generating energy for ejecting the liquids.

In the case where the liquid ejection head is not used for a long time period, the liquids may be concentrated or thickened inside the liquid ejection head. In order to prevent such a situation, the circulation of the liquids may be performed.

Japanese Patent Laid-Open No. 2020-104493 discloses a printing element substrate that includes first pumps that circulate liquid between a common channel and pressure chambers formed in the printing element substrate, a second pump provided at a position different from the printing element substrate, and printing elements.

With the printing element substrate according to Japanese Patent Laid-Open No. 2020-104493, the circulation of the liquid by the first pumps and the second pump achieves the ejection of a desired liquid from ejection ports even after the state where the liquid is not ejected has continued for a long time period.

The printing element substrate according to Japanese Patent Laid-Open No. 2020-104493 includes a substrate (element substrate) including the first pumps (circulation elements) and the printing elements. The substrate of the printing element substrate is provided with various drivers and various wiring lines to drive the first pumps and the printing elements, which is not mentioned in Japanese Patent Laid-Open No. 2020-104493. The printing element substrate according to Japanese Patent Laid-Open No. 2020-104493 is susceptible to improvement in the arrangement of the printing elements, the circulation elements, and the wiring lines to prevent the printing element substrate from increasing in size.

### SUMMARY

Hence, an object of a technique according to the present disclosure is to provide a printing element substrate on which printing elements, circulation elements, and wiring lines are arranged efficiently.

A printing element substrate includes a first unit including a first element and a second element, a second unit including a third element and a fourth element, and a power supply wiring line including a first portion supplying electric power to the first unit, and a second portion supplying electric power to the second unit, wherein the power supply wiring line includes an extension portion that extends along a boundary line between the first unit and the second unit, the first element and the third element are arranged symmetrically with respect to the extension portion, the second element and the fourth element are arranged symmetrically with respect to the extension portion, and the first portion and the second portion are arranged symmetrically with respect to the extension portion.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a liquid ejection apparatus that is applicable to an embodiment.

FIG. 2A is an exploded perspective view illustrating an example of a liquid ejection head that is applicable to the embodiment.

FIG. 2B is a general view illustrating an example of a printing element substrate that is applicable to the embodiment.

FIG. 3A is a schematic plan view of the vicinity of ejection ports 11 as viewed along a direction in which droplets are ejected.

FIG. 3B is a diagram for describing a first flow.

FIG. 3C is a diagram for describing a second flow.

FIG. 4A is a diagram illustrating a growth process of a bubble B after generation of the bubble B caused by film boiling of a liquid by driving of a circulation heater RhB.

FIG. 4B is a diagram for describing a contraction process of the bubble B.

FIG. 4C is a diagram for describing a process after the bubble B has disappeared.

FIG. 5A is an explanatory diagram illustrating how concentrating of a liquid is eliminated.

FIG. 5B is an explanatory diagram illustrating how the concentrating of the liquid is eliminated.

FIG. 5C is an explanatory diagram illustrating how the concentrating of the liquid is eliminated.

FIG. 5D is an explanatory diagram illustrating how the concentrating of the liquid is eliminated.

FIG. 6 is a diagram illustrating an example of a circuit configuration that is applicable to the embodiment.

FIG. 7A is a schematic diagram of a control-data supply circuit that is applicable to the embodiment.

FIG. 7B is a schematic diagram of a circulation-group selection circuit that is applicable to the embodiment.

FIG. 8 is a schematic diagram illustrating arrangement on an element substrate that is applicable to the embodiment.

FIG. 9 is a schematic enlarged view illustrating a part of a wiring configuration that is applicable to the embodiment.

FIG. 10 is a diagram illustrating a comparative example of the wiring configuration of the element substrate.

FIG. 11 is a schematic enlarged view illustrating a part of the wiring configuration that is applicable to an embodiment.

FIG. 12 is a schematic enlarged view illustrating a part of the wiring configuration that is applicable to an embodiment.

FIG. 13 is a schematic enlarged view illustrating a part of the wiring configuration that is applicable to an embodiment.

FIG. 14 is a diagram showing the relationship of FIGS. 14A and 14B. FIGS. 14A and 14B are totally a schematic enlarged view illustrating a part of the wiring configuration that is applicable to an embodiment.

FIG. 15 is a diagram showing the relationship of FIGS. 15A to 15D. FIGS. 15A to 15D are totally a schematic enlarged view illustrating a part of the wiring configuration that is applicable to an embodiment.

FIG. 16A is a plan view of a configuration of channels in a printing element substrate that is applicable to an embodiment, as viewed along a direction in which droplets are ejected.

FIG. 16B is a cross-sectional view taken along a line XVIb-XVIb in FIG. 16A.

FIG. 17A is a schematic plan view of a configuration of channels in a printing element substrate that is applicable to the present embodiment, as viewed along a direction in which droplets are ejected.

FIG. 17B is a cross-sectional view taken along a line XVII-XVII in FIG. 17A.

FIG. 17C is a diagram illustrating a modification of the channels applicable to the embodiment.

FIG. 18A is a schematic plan view of the vicinity of ejection ports.

FIG. 18B is a cross-sectional view taken along a line XVIIIb-XVIIIb in FIG. 18A.

FIG. 18C is an enlarged view of a focused channel out of the channels in FIG. 18A.

FIG. 19A is a drawing illustrating an example of a printing element substrate that is applicable to an embodiment.

FIG. 19B is a drawing illustrating an example of a printing element substrate that is applicable to the present embodiment.

FIG. 20 is a diagram illustrating an example of a liquid ejection apparatus that is applicable to an embodiment.

FIG. 21 is a schematic cross-sectional view of a printing element substrate that is applicable to an embodiment.

### DESCRIPTION OF THE EMBODIMENTS

Hereinafter, preferred embodiments of the present disclosure will be described in detail with reference to the accompanying drawings. Note that the embodiments to be described below are not intended to limit the matters of the present disclosure, and all of the combinations of features described in the present embodiments are not necessarily essential to solutions provided in the present disclosure. Note that the same constitute element will be given the same reference sign, and the description of components with the same reference sign will be omitted as appropriate. In the following description, a basic configuration of the present disclosure will be described first, and features of the present disclosure will then be described.

### First Embodiment

### <Liquid Ejection Apparatus 50>

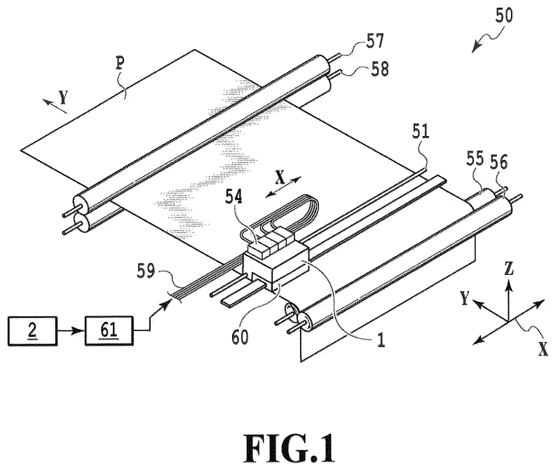

FIG. 1 is a schematic perspective view illustrating an example of a liquid ejection apparatus 50 that is applicable to the present embodiment.

The liquid ejection apparatus 50 illustrated in FIG. 1 is capable of performing printing by ejecting liquids onto a print medium P with a liquid ejection head 1 that performs scanning in a scanning direction (an X-direction) intersecting a conveying direction of the print medium P (a Y-direction) in plane. That is, in the present embodiment, the liquid ejection apparatus 50 of what is called a serial type is used. The liquid ejection head 1 is capable of ejecting liquids (e.g., inks). For example, the liquid ejection head 1 ejects inks of four colors including black (K), cyan (C), magenta (M), and yellow (Y). Ejecting these inks, the liquid ejection head 1 can print a full color image. Inks ejected from the liquid ejection head 1 are not limited to the inks of the above four colors. An ink of another color may be ejected from the liquid ejection head 1. That is, the colors and the number of inks ejected from the liquid ejection head 1 are not limited.

The liquid ejection head 1 is detachably mounted on a carriage 60. The carriage 60 reciprocally moves along a guide shaft 51 and along a main scanning direction (the X-direction). The print medium P is conveyed by conveying unit in the conveying direction (the Y-direction), which intersects (in the present embodiment, is orthogonal to) the scanning direction (the X-direction). The conveying unit includes a first conveying roller 55, a second convey roller 56, a third convey roller 57, and a fourth convey roller 58. Note that, in the drawings to be referred to hereinafter, a Z-direction indicates a vertical direction. The Z-direction intersects (in the present embodiment, is orthogonal to) an X-Y plane defined by the X-direction and the Y-direction.

In the present embodiment, main tanks 2 that function as liquid reservoirs are provided outside the liquid ejection head 1. Liquids stored in the main tanks 2 are supplied via supply tubes 59 and the like to sub tanks 54 included in the liquid ejection head 1 by driving force generated by external pumps 61. The liquid ejection head 1 is fixed to the carriage 60 with a positioning unit and electrical contacts, which are not illustrated. The liquid ejection head 1 ejects the liquids while moving in the scanning direction (the X-direction) together with the carriage 60, thus performing printing on the print medium P.

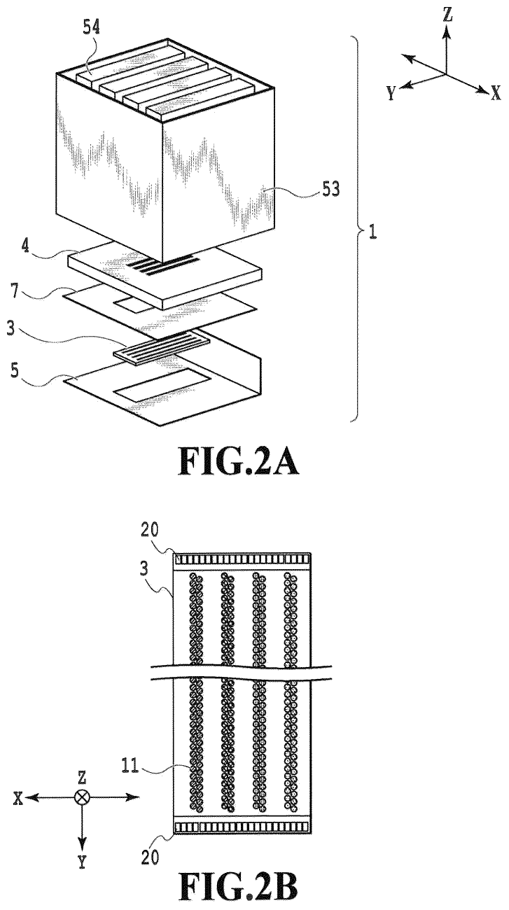

The supply tubes 59 are connected to the external pumps 61 that are connected to the main tanks 2 serving as supply sources of the inks. The supply tubes 59 are provided with, at their tip ends, connectors not illustrated. With the liquid ejection head 1 mounted on the liquid ejection apparatus 50, connectors of the supply tubes 59 at their other ends are connected in a liquid-tight manner to connector insertion slots that are provided on a case 53 (see FIG. 2A) of the liquid ejection head 1 and serve as inlets of the liquids. This forms liquid supply channels from the main tanks 2 via the external pumps 61 to the liquid ejection head 1.

In the present embodiment, the four types of liquids described above are used. Accordingly, four sets each including a main tank 2, an external pump 61, a supply tube 59, and a sub tank 54 are provided corresponding to the four types of liquids. That is, in the present embodiment, four liquid supply channels corresponding to the types of liquids are formed independently. As seen from the above, the liquid ejection apparatus 50 of the present embodiment includes a liquid supply system that supplies the liquids from the main tanks 2.

Note that the liquid ejection apparatus 50 of the present embodiment does not include a liquid collection system that collects liquids remaining inside the liquid ejection head 1 to the main tanks 2. Therefore, the liquid ejection head 1 is provided with connector insertion slots for connecting tubes used to collect the liquids.

### <Liquid Ejection Head 1>

FIG. 2A is an exploded perspective view illustrating an example of the liquid ejection head 1 that is applicable to the present embodiment.

As illustrated in FIG. 2A, the liquid ejection head 1 includes the sub tanks 54 that temporarily store the liquids therein and a printing element substrate 3 that causes liquids supplied from the sub tanks 54 to be ejected onto the print medium P (see FIG. 1). The liquid ejection head 1 includes a channel forming substrate 4 that includes channels connecting the sub tanks 54 and the printing element substrate 3, a support substrate 7 that supports the channel forming substrate 4, and a face cover 5 that covers the support substrate 7 except the printing element substrate 3.

In the liquid ejection head 1, the ejection of a liquid may become unstable. For example, the ejection of a liquid becomes unstable when a volatile component (e.g., moisture, etc.) evaporates from ejection ports 11 from which the liquid is ejected (see FIG. 2B, etc.), thereby concentrating solid contents in the liquid near the ejection ports 11. In order to prevent such a situation, it is conceivable to contrive various arrangements for the liquid ejection head 1.

Examples of the arrangements include the provision of a cap member (not illustrated) covering an ejection port surface on which the ejection ports 11 are formed at a position away from a conveyance path of the print medium P (see FIG. 1) in the X-direction. By covering the ejection port surface with the cap member when, for example, a printing operation is not performed so as to protect the ejection port surface, the ejection ports 11 can be prevented from drying, and it is thus possible to prevent the evaporation of the volatile component.

Additionally, a suction mechanism (not illustrated) for suctioning the liquids may be provided. In this case, the cap member is used to perform, for example, a suction operation of suctioning the liquids from the ejection ports 11. By the suction operation, the liquids near the ejection ports 11 can be refreshed, and it is thus possible to keep the resultant grade of image quality.

Concentrated liquids may be discarded by performing preliminary discharge when a printing operation is not performed. Furthermore, during the printing operation, small amounts of liquids may be preliminary discharged on the print medium P at a position where the liquids are inconspicuous in terms of image quality.

The preliminary discharge and the suction operation significantly contribute to keeping the grade of image quality. In contrast, the preliminary discharge and the suction operation are required to minimize the amounts of discarded liquids. In contrast, the circulation of the liquids in the printing element substrate as described later can prevent the liquids from being concentrated, thickened, and the like to keep the grade of image quality without discarding liquids.

For example, as with the technique described in Japanese Patent Laid-Open No. 2020-104493, by the driving of a pump (a circulation element) provided on a substrate of the printing element substrate to perform the circulation, it is possible to implement the prevention of the drying of the ejection ports and the concentrating of the liquids with reduced amounts of discarded liquids. With such a technique, it is possible to implement the minimization of the numbers of times of the preliminary discharge and the suction operation. Furthermore, the minimization of the numbers of times of the preliminary discharge and the suction operation implements an improvement in throughput and yield.

Note that the circulation element need not be provided to every channel (individual channels described later) in the liquid ejection head 1. Providing the circulation element to each of some of the channels can make an improvement in throughput and yield compared with the case where the circulation element is not provided.

The liquid ejection head 1 may be provided with the circulation element at every location corresponding to the four types of liquids or may be provided with the circulation element at only a location corresponding to one of the types of liquids. That is, the liquid ejection head 1 may be configured to enable the circulation of all the liquids of the four types or may be configured to enable the circulation of only the liquid of the one of the types.

### <Printing Element Substrate 3>

FIG. 2B is a general view illustrating an example of the printing element substrate 3 that is applicable to the present embodiment.

FIG. 2B illustrates one printing element substrate 3 capable of ejecting the liquids of the four types. The printing element substrate 3 is provided with the ejection ports 11 from which the liquids are ejected and pads 20 that are used for electric mounting. The printing element substrate 3 ejects, for example, black, cyan, magenta, and yellow inks. The ejection ports 11 through which the liquid of each color is ejected are formed along the Y-direction (a first direction), and these ejection ports 11 form one ejection port array.

In each ejection port array, every two adjacent ejection ports 11 are arranged being offset in the X-direction (a second direction), and the ejection ports 11 in a large number are arranged along the Y-direction at regular intervals. Note that, in each ejection port array, its ejection ports 11 may be arranged in one line along the Y-direction without the offsetting of the ejection ports 11 in the X-direction. Alternatively, two ejection port arrays ejecting a black ink may be formed, and five ejection port arrays ejecting the four colors may be formed.

The example of the combination of the types of liquids to be ejected from the printing element substrate 3 is not limited to the example described above. Furthermore, the types of the liquid to be ejected from the printing element substrate 3 are not limited to the four types described above.

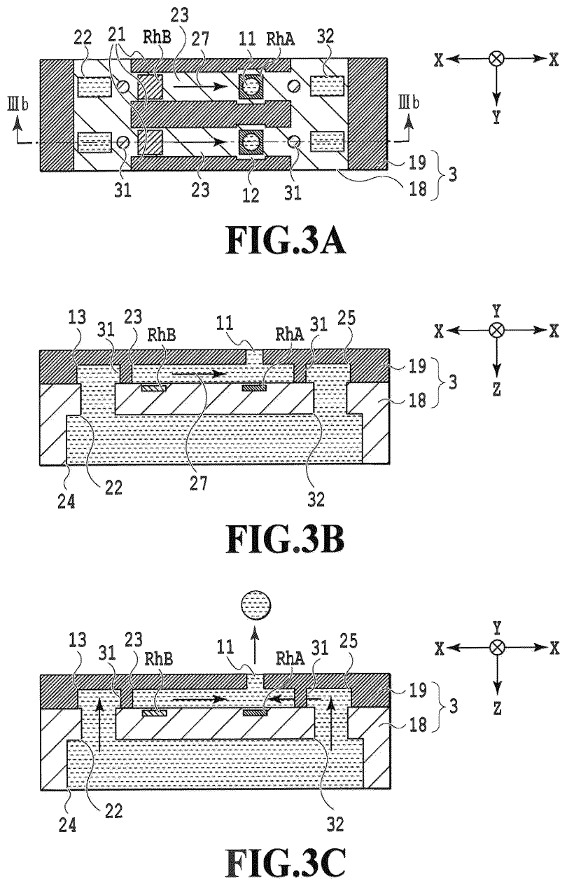

FIGS. 3A to 3C are schematic diagrams for describing the configuration of channels m the printing element substrate 3 that is applicable to the present embodiment.

FIG. 3A is a schematic plan view of the vicinity of the ejection ports 11 as viewed along a direction in which droplets are ejected. FIGS. 3B and 3C are cross-sectional views taken along the line IIIb-IIIb in FIG. 3A.

As illustrated in FIGS. 3B and 3C, the printing element substrate 3 includes an ejection port forming member 19 through which the ejection ports 11 are formed and an element substrate 18 that includes an energy-generating element giving a liquid energy. The element substrate 18 includes first ejection elements generating energy for ejecting liquid and first circulation elements generating energy for circulating liquid.

In the present embodiment, electrothermal transducer elements are used as the first ejection elements and the first circulation elements. As the first ejection elements, ejection heaters RhA are used. As the first circulation elements, circulation heaters RhB are used. Note that piezoelectric elements may be used as the first ejection elements, and piezoelectric elements may be used as the first circulation elements.

The element substrate 18 is formed with first supply ports 22 and second supply ports 32 that are connected to channels formed in the ejection port forming member 19. In the present embodiment, the first supply ports 22 and the second supply ports 32 are independent supply ports that are independent of one another.

In the state where the ejection port forming member 19 and the element substrate 18 are bonded together, the ejection port forming member 19 is formed with a plurality of partitions 21 that partition the inside of the printing element substrate 3. The partitions 21 extend along a transverse direction in which a short side of the printing element substrate 3 extends (the X-direction). This forms individual channels 23 of a straight type in the printing element substrate 3 of the present embodiment.

In the present disclosure, the “straight type” means a form in which a first ejection element and a first circulation element are arranged on one channel, both end portions of the channel are positioned across an ejection port, and the channel extends along a direction that intersects, in plane, a direction in which an ejection port array extends. That is, the printing element substrate 3 of the present embodiment, which includes channels of the straight type, the ejection heaters RhA and the circulation heaters RhB are provided along a direction (a second direction, the X-direction) that is orthogonal, in plane, to the direction in which the ejection port array extends (the first direction, the Y-direction).

The channels of the printing element substrate 3 may be provided with filters 31 that remove a foreign substance in liquid. In the present embodiment, the filters 31 are provided outside the individual channels 23 formed in the ejection port forming member 19. Specifically, the filters 31 are provided on the inflow side and outflow side of the individual channels 23. Note that filters 31 may be provided between the ejection heaters RhA and the circulation heaters RhB in the individual channels 23. In this case, the filters 31 on the outside and on the upstream side (a side on which the circulation heaters RhB are provided) of the individual channels 23 need not be provided.

The flow of liquid flowing through the individual channels 23 is roughly divided into two flows. The first one is a first flow (a circulatory flow 27) that is generated by the driving of the circulation heaters RhB and circulates the liquid. As described above, both ends of each individual channel 23 of the straight type are opposed to each other in the second direction. That is, in an individual channel 23 of the straight type, the inlet for the circulatory flow 27 and the outlet for the circulatory flow 27 are opposed to and distant from each other. With this configuration, fresh liquid is supplied through the inlets of the individual channels 23 immediately after concentrated liquid is discharged through the outlets of the individual channels 23, and it is thus possible to prevent the discharged liquid from entering the individual channels 23 from their inlets.

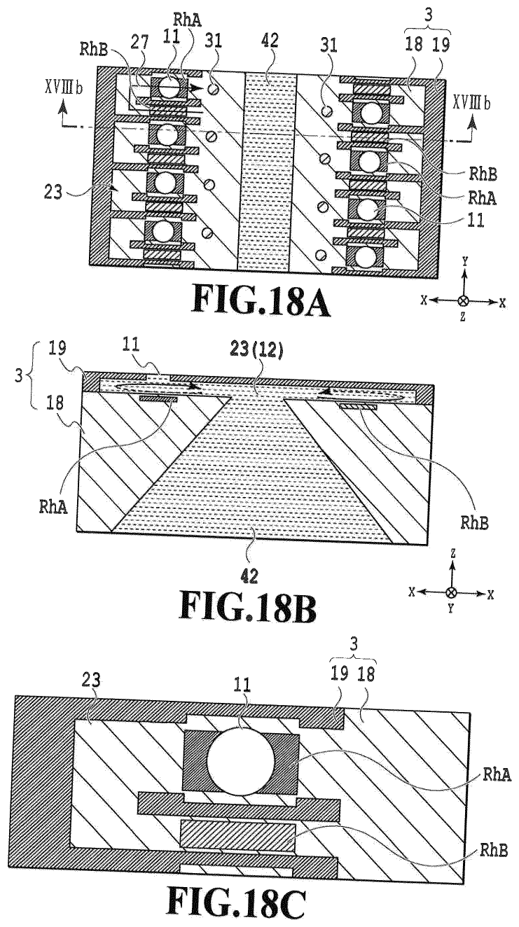

In the case of U-shaped channels to be described later with reference to FIGS. 18A to 18C, the inlet and outlet of each individual channel are provided close to each other, and thus concentrated liquid discharged from the outlet may reenter the individual channel from the inlet. That is, in the case of the U-shaped channels, the concentrating of liquid may fail to be sufficiently eliminated even when the circulation is performed. In contrast, the individual channels 23 of the straight type are capable of preventing such a situation from arising compared with the U-shaped channels.

The second one is a second flow that is generated by refilling after ejection caused by the driving of the ejection heaters RhA. Hereinafter, the first flow will be described with reference to FIG. 3B, and the second flow will be described with reference to FIG. 3C.

FIG. 3B is a diagram for describing the first flow. Note that FIG. 3B is a cross-sectional view taken along the line IIIb-IIIb in FIG. 3A.

As illustrated in FIG. 3B, the element substrate 18 is formed with common channels 24 that are connected to the first supply ports 22 and the second supply ports 32. In the state where the element substrate 18 and the ejection port forming member 19 are bonded together, the common channels 24 are connected to channels formed in a member that is bonded to a surface facing in an opposite direction to a direction in which the bonding surface between the element substrate 18 and the ejection port forming member 19 faces. In this manner, in the state where the element substrate 18 and the ejection port forming member 19 are bonded together, the element substrate 18 is formed with the channel that penetrates the element substrate 18 in the Z-direction.

The ejection port forming member 19 is formed with first connection channels 13 that are positioned on the inlet (upstream) side of the individual channels 23 and second connection channels 25 that are positioned on the outlet (downstream) side of the individual channels 23. At one ends of the individual channels 23 that are on the upstream side, the first connection channels 13 are connected to the first supply ports 22. At the other ends of the individual channels 23 that are on the downstream side, the second connection channels 25 are connected to the second supply ports 32. In this manner, both end portions of each individual channel 23 are positioned on opposite sides across the corresponding ejection port 11.

The first connection channels 13 are positioned closer to the circulation heaters RhB than to the ejection ports 11. In FIG. 3B, menisci of liquid are formed on the ejection ports 11. That is, the ejection port 11 illustrated in FIG. 3B is in the state where an ejection port interface is formed as an interface between the liquid and the atmosphere. When the circulation heaters RhB positioned closer to the first supply ports 22 than to the second supply ports 32 is driven in this state, the circulatory flow 27 for circulating the liquid is produced.

The production of the circulatory flow 27 causes the liquid to flow in the order of the common channels 24, the first supply ports 22, the first connection channels 13, the individual channels 23, the second connection channels 25, and the second supply ports 32. The liquid then returns to the common channels 24. In this manner, the circulation in which the liquid returns from the second supply ports 32, passes the common channels 24, and flows again into the first supply ports 22 is performed in the present embodiment.

FIG. 3C is a diagram for describing the second flow. The description will be given with reference to FIG. 3C, which is the same cross section as FIG. 3B.

As illustrated in FIG. 3C, the element substrate 18 is provided with the ejection heaters RhA at positions corresponding to the ejection ports 11. The ejection heaters RhA are positioned closer to the second supply ports 32 than to the first supply ports 22.

When the liquid is ejected from the ejection ports 11, the liquid is supplied from the first supply ports 22 and the second supply ports 32 to the first connection channels 13 and the second connection channels 25, respectively. The individual channels 23 are then refilled with the liquid from both the first connection channels 13 and the second connection channels 25.

In the state where the individual channels 23 are refilled with the liquid, by the driving of the ejection heaters RhA generates bubbles in the liquid present in the individual channels 23, droplets can be ejected from the ejection ports 11 by method of bubble generating energy. In this manner, the individual channels 23 of the present embodiment also function as pressure chambers.

### <Principle Behind Production of Circulatory Flow 27>

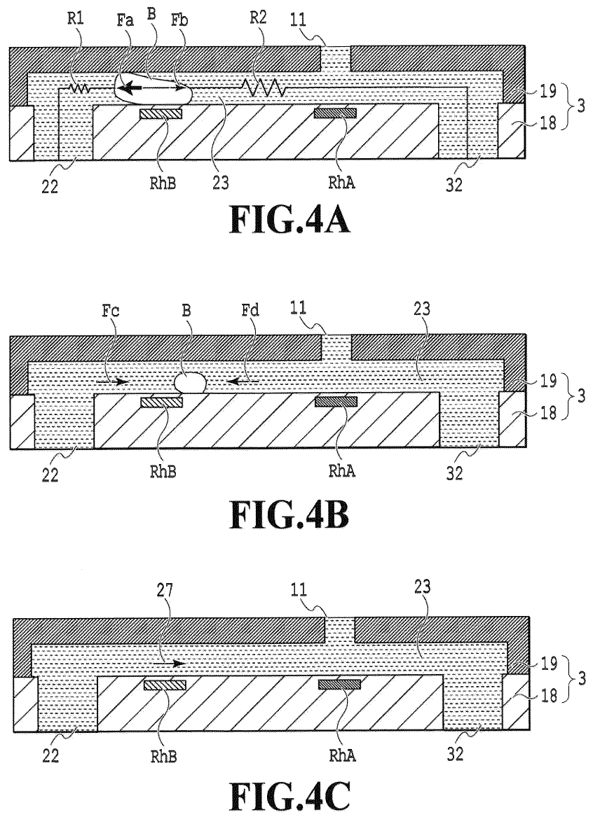

FIGS. 4A to 4C are diagrams for describing the principle behind the production of the circulatory flow 27. Cross sections illustrated in FIGS. 4A to 4C are the same cross section as in FIG. 3B. Note that the filters 31 (see FIG. 3A, etc.) are not illustrated for convenience of description.

FIG. 4A is a diagram illustrating the growth process of a bubble B after the generation of the bubble B caused by film boiling of the liquid by the driving of a circulation heater RhB. FIG. 4A illustrates an equivalent circuit in which a first flow resistance R1 and a second flow resistance R2 are represented as, for example, electric resistances.

As illustrated in FIG. 4A, the driving of the circulation heater RhB generates the bubble Bin the liquid flowing in the corresponding individual channel 23.

The circulation heater RhB is positioned closer to the corresponding first supply port 22 than to the corresponding second supply port 32. Therefore, the first flow resistance R1, which is a flow resistance between the circulation heater RhB and the corresponding first supply port 22, is smaller than the second flow resistance R2, which is a flow resistance between the circulation heater RhB and the corresponding second supply port 32. The difference between the first flow resistance R1 and the second flow resistance R2 causes the growth of the bubble B generated by the film boiling of the liquid to be biased toward the first supply port 22 side where the first flow resistance R1 being smaller is present. As a result, in the individual channel 23, a flow Fa of the liquid to the first supply port 22 is larger than a flow Fb of the liquid to the second supply port 32.

FIG. 4B is a diagram for describing the contraction process of the bubble B.

As illustrated in FIG. 4B, in the contraction process of the bubble B, the liquid flows in from the first supply port 22 and the second supply port 32 so as to compensate for a volume by which the bubble B contracts, thus producing a flow Fe and a flow Fd. As described above, the first flow resistance R1 (see FIG. 4A) on the first supply port 22 side is smaller than the second flow resistance R2 on the second supply port 32 side. As a result, the flow Fe of the liquid flowing in from the first supply port 22 is larger than the flow Fd of the liquid flowing in from the second supply port 32. In addition, the bubble B contracts on the second supply port 32 side of the circulation heater RhB. The bubble B then disappears at a position offset to the second supply port 32 side from the circulation heaters RhB.

FIG. 4C is a diagram for describing a process after the bubble B has disappeared.

As described above, the flow Fe is larger than the flow Fd. This produces the circulatory flow 27 of the liquid from the first supply port 22 to the second supply port 32. The circulatory flow 27 changes in magnitude under the effect of the first flow resistance R1, the second flow resistance R2, and the bubble B. The circulation heater RhB is preferably positioned closer to one of both end portions of the individual channel 23 than the corresponding ejection heater RhA. In addition, it is preferable that the value of the division of the first flow resistance R1 by the second flow resistance R2 (R1/R2) be between 0.05 and 0.40 both inclusive.

By setting the value of first flow resistance R1/second flow resistance R2 such that the value falls within the above range, the circulatory flow 27 can have its maximum value. It is important for the circulatory flow 27 to make the flow Fa of the liquid to the first supply port 22 large to increase the flow Fe of the liquid flowing in from the first supply port 22. It is therefore effective to make the first flow resistance R1 small.

It is also important to make the flow Fb of the liquid to the second supply port 32 as small as possible to decrease the flow Fd of the liquid flowing in from the second supply port 32. It is therefore effective to make the second flow resistance R2 large. From the above, it is important to make the first flow resistance R1 small and the second flow resistance R2 large, that is, make the value (R1/R2) of first flow resistance R1/second flow resistance R2 smaller than 1. In addition, the bubble B being large, that is, the bubble B having a large volume leads to an increase in a volume by which fluid produced in the individual channel 23 is discharged, and thus increasing the magnitude of the circulatory flow 27 large.

Examples of a method of increasing the volume of the bubble include increasing the size of the circulation heaters RhB and decreasing the flow resistances by increasing the individual channels 23 in width and height. The examples also include decreasing the viscosity of the liquid, increasing the temperature of the liquid ejection head 1 (see FIG. 1), and using a double pulse as a driving pulse.

A part of the circulatory flow 27 flows into the ejection ports 11, and thus the liquid concentrated inside the ejection ports 11 is sent to the second supply port 32 side. Fresh liquid then flows into the ejection ports 11 from the first supply port 22 side through the individual channels 23. By making it difficult for the concentrated liquid to stay inside the ejection ports 11 in this manner, it is possible to mitigate the effect of the concentrate liquid, keeping the liquid in a good ejection condition when the ejection operation is started.

The circulatory flow 27 is a transitory flow that is produced in the growth process and the contraction process of the bubble B. Therefore, after the bubbles B disappear, this inertial flow is attenuated with time to stop after a certain time period. It is therefore necessary to repeatedly drive the circulation heaters RhB so as to produce the circulatory flow 27 steadily for a given time period. A driving cycle of the circulation heaters RhB is not limited as long as the concentrated liquid in the ejection ports 11 can be discharged.

However, when a driving frequency of around 100 kHz is used for the driving with consideration given to a cycle of 10 μs, which is a time period it takes for the bubble B from its generation to its disappearance, the effect of the circulation is not very high. Therefore, in order to produce a suitable effect of the circulation, it is preferable to drive the circulation heaters RhB in a cycle of, for example, 100 Hz to several tens kHz.

The higher the driving frequency, the more the circulatory flow 27 is maintained, and the stronger the effect of discharging the concentrated liquid. At the same time, it is necessary to take into account a temperature rise of the liquid due to heat generated by the driving of the circulation heaters RhB. It is therefore necessary to appropriately drive the circulation heaters RhB.

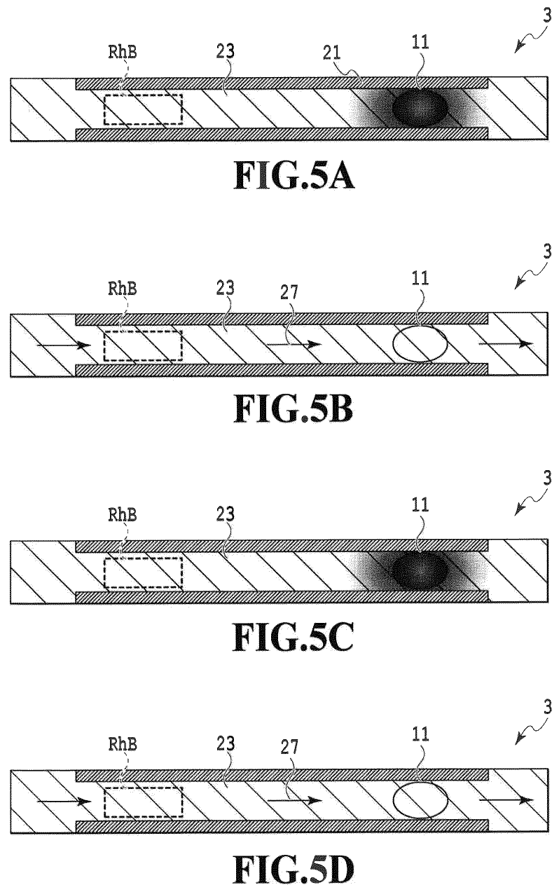

FIGS. 5A to 5D are explanatory diagrams illustrating how the concentrating of the liquid is eliminated. In FIGS. 5A to 5D, a dark color indicates a location where the liquid is concentrated, and degrees of the concentrating are represented by gradations of color.

As illustrated in FIG. 5A, when the circulation heaters RhB are temporarily stopped, a volatile component in the liquid evaporates from the ejection ports 11, thereby concentrating the liquid in the vicinities of the ejection ports 11.

As illustrated in FIG. 5B, by driving the circulation heaters RhB to produce the circulatory flow 27, the concentrating of the liquid in the vicinities of the ejection ports 11 can be eliminated.

As illustrated in FIG. 5C, when the circulation heaters RhB are temporarily stopped again, the liquid concentrates in the vicinities of the ejection ports 11.

As illustrated in FIG. 5D, by driving the circulation heaters RhB again to produce the circulatory flow 27, the concentrating of the liquid in the vicinities of the ejection ports 11 can be eliminated.

As described above, in the individual channels 23 of the straight type, the concentrated state of the liquid is reset every time the temporary stop of the circulation heaters RhB and the circulation operation alternate.

### <Ink>

As described above, the liquid can be kept in a good ejection condition by the circulation in the present embodiment. It is therefore possible to reduce a change in ejection speed and the like, thus stabilizing the ejection.

Depending on the application of the liquid ejection apparatus 50 on which the liquid ejection head 1 is mounted (see FIG. 1), inks that differ in the type of coloring material, the content of solid contents, and the like may be used. That is, the liquid ejection head 1 preferably has such a performance that can maintain a high-level ejection stability with whatever type of an ink.

For example, inks with reduced moisture may be used to deal with possible problems resulting from moisture in ink (e.g., cuRling (warpage), cockling (undulating wrinkles), etc., in ordinary paper). The inks with reduced moisture tend to increase in the concentration of solid contents, other than water, such as organic solvent, pigment, resin, and the like. Therefore, the inks with reduced moisture are likely to rapidly increase in viscosity as the moisture evaporates and may decrease the stability of the ejection.

The method of producing the circulatory flow 27 in the individual channels 23 is highly effective for such inks because of being capable of preventing the inks from increasing in viscosity. In general, an ink with a large amount of solid contents has 10 wt % or higher of solid contents. For example, the technique according to the present disclosure is preferably applied to inks in which the content of solid contents is IO wt % (mass %) or higher.

In addition, the viscosity of an ink changes in accordance with the temperature of the ink, and thus a temperature at which the liquid ejection head 1 is operated may have an influence on the viscosity of the ink, and by extension on the stability of the ejection. Therefore, the entire substrate can be heated to a certain temperature with the circulation heaters RhB arranged on the printing element substrate 3.

In the case where the circulatory flow 27 is generated by the driving of the circulation heaters RhB, the flow speed of the circulation can be set within the range from several tens mm/s to 1000 mm/s both inclusive in terms of instantaneous flow speed. On the order of several hundred microseconds, the method flow speed of the circulatory flow 27 depends on the driving frequency of the circulation heaters RhB. This is because the circulatory flow 27 is attenuated with time to stop after the certain time period. In the case where the circulation heaters RhB are driven at a driving frequency (ejection frequency) on par with that of the ejection heaters RhA (from about 10 kHz to about 20 kHz both inclusive), the method flow speed of the circulatory flow 27 can be set within the range from several mm/s to 100 mm/s both inclusive.

In the case where a pigment ink having a relatively high concentration (e.g., an ink having a viscosity from 3 cp to 6 cP both inclusive at the temperature at which the liquid ejection head 1 is operated) is used, the ink tends to be thickened at the ejection ports 11 in accordance with a non-ejection time period (stop time). Therefore, in the case where an ink having a relatively high pigment concentration is used, the ejection speed tends to change, which may lead a decrease in ejection stability.

In this case, it is therefore necessary to circulate the ink during a relatively short time period. For example, it is necessary to perform a steady or transitory circulation at high frequency during an intermission period of the liquid ejection head 1 to eliminate the concentration of the ink. In the case where the circulation heaters RhB are used, the transitory circulation is performed. Performing a transitory circulation operation at high frequency contributes to the elimination of the concentration of the ink at the ejection ports 11.

In contrast, in the case where a pigment ink having a relatively low concentration (e.g., an ink having a viscosity from 1 cp to 2 cP both inclusive at the temperature at which the liquid ejection head 1 is operated) is used, the ejection speed may change in accordance with the stop time of the liquid ejection head 1. However, the influence of the case is relatively minor compared with the case where the ejection speed of the ink having the high concentration changes.

An ink may be thickened at the ejection ports 11 in accordance with the stop time of the liquid ejection head 1. Therefore, when the operation of the liquid ejection head 1 is resumed after the liquid ejection head 1 is stopped for a certain time period or longer, it is therefore necessary to perform a recovery process (a suction operation, a wiping operation, or a preliminary ejection including the combination thereof, etc.). However, in the recovery process, ink is discarded. Thus, in the present embodiment, the concentration of the inks at the ejection ports 11 is eliminated without waste ink by performing a recovery operation of producing the circulatory flow 27.

With some stop time of the liquid ejection head 1, only performing the circulation operation enables the recovery of the ejection performance of the liquid ejection head 1 without waste ink. Another possible recovery process for minimizing waste ink is such that combines the circulation operation for the recovery of the ejection performance with, as a part of the process, a suction operation or the like for removing bubbles in the head in addition to the suction operation for eliminating the concentrating. Note that, in order to prevent the influence of concentrated ink, it is desirable to restore the state of the ink to its initial, fresh state irrespective of the concentration of the ink.

### <Element Substrate 18>

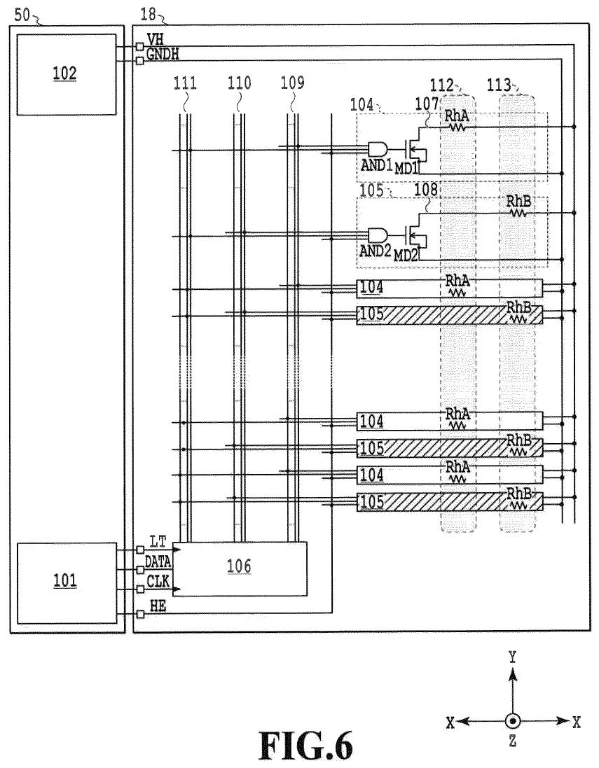

FIG. 6 is a diagram illustrating an example of the circuit configuration of the element substrate 18 that is applicable to the present embodiment.

As illustrated in FIG. 6, the liquid ejection apparatus 50 includes a power circuit 102 that supplies the element substrate 18 with electric power and a controller 101 that sends an enable signal to the element substrate 18.

The element substrate 18 includes ejection modules 104 for ejecting liquid, circulation modules 105 for circulating the liquid, and a control-data supply circuit 106 that outputs various signals. The element substrate 18 includes time-sharing selection signal lines 111, circulation-group selection signal lines 110, and ejection-group selection signal lines 109 that are connected to the control-data supply circuit 106.

The ejection modules 104 each include the ejection heater RhA, an ejection driving element MD1 for causing current to flow to the ejection heater RhA and an ejection wiring line 107 for connecting the ejection heater RhA and the ejection driving element MD1 The ejection wiring line 107 is a drain wiring line. The ejection driving element MD1 is a transistor for driving the ejection heater RhA. The ejection heater RhA may additionally have a role as a circulation heater for circulating the liquid, an element that heats a specific area of the printing element substrate, a temperature detecting element that monitors temperature information on the heater, or the like.

The ejection modules 104 each include a first logic circuit AND1 for selectively driving the ejection driving element MD1 Current flowing through the ejection heaters RhA generates heat, which generates bubbles in the liquid to eject the liquid, and thus printing on a printing surface of the print medium P (see FIG. 1) can be performed. The multiple ejection heaters RhA are arranged in a line along the Y-direction to form an ejection heater array 112 (ejection element array).

The circulation modules 105 each include the circulation heater RhB, a circulation driving element MD2 for causing current to flow to the circulation heater RhB and a circulation wiring line 108 for connecting the circulation heater RhB and the circulation driving element MD2. The circulation wiring line 108 is a drain wiring line. The circulation driving element MD2 is a transistor for causing current to flow to the circulation heaters RhB. The circulation modules 105 each include a second logic circuit AND2 for selectively driving the circulation driving element MD2.

Current flowing through the circulation heaters RhB generates heat, which causes the bubbles B to grow, and thus the circulatory flows 27 (see FIGS. 4A to 4C, etc.) can be produced in the individual channels 23. The multiple circulation heaters RhB are arranged in a line along the Y-direction to form a circulation heater array 113 (circulation element array). The circulation heater RhB may have a role as an ejection heater for ejecting the liquid, an element that heats a specific area of the printing element substrate, a temperature detecting element that monitors temperature information on the heater, or the like.

In each of the ejection modules 104, an ejection-group selection signal and a time-sharing selection signal that are output from the control-data supply circuit 106, and an enable signal to control a pulse width (a time period during which the ejection driving element MD1 is turned on to cause the current to flow) are input into the first logic circuit AND1. The ejection-group selection signal is input through the corresponding ejection-group selection signal line 109. The time-sharing selection signal is input through the corresponding time-sharing selection signal line 111. The enable signal is input through an enable signal line HE. These input signals perform selective control such that the ejection driving element MD1 is brought into a conductive state, causing the current to flow to the ejection heater RhA.

In each of the circulation modules 105, a circulation-group selection signal, the time-sharing selection signal, and the enable signal are input into the second logic circuit AND2. The circulation-group selection signal is output from the control-data supply circuit 106 and input through the corresponding circulation-group selection signal line 110. These input signals perform selective control such that the second logic circuit AND2 is brought into a conductive state, causing the current to flow to the corresponding circulation heater RhB.

Sharing a signal line for sending the time-sharing selection signal between an ejection module 104 and a circulation module 105 contributes to a reduction in the amount of transferred serial data and a reduction in the layout area of signal wiring lines inside the element substrate 18 (described later).

The element substrate 18 includes an external input terminal of the enable signal. The enable signal is sent from the controller 101. The enable signal controls the pulse widths of the ejection driving elements MD1 and the circulation driving elements MD2 of selected ejection modules 104 and circulation modules 105 (time periods during which the transistors are turned on to cause the currents to flow). In the production of the element substrate 18, variations in heater resistance value, variations in power supply and the like, and voltage drops in power supply wiring lines caused when a plurality of heaters are driven simultaneously, and the like may occur. The enable signal is used to adjust the pulse widths of the currents such that more desired thermal energy can be generated with consideration given to these variations and the like.

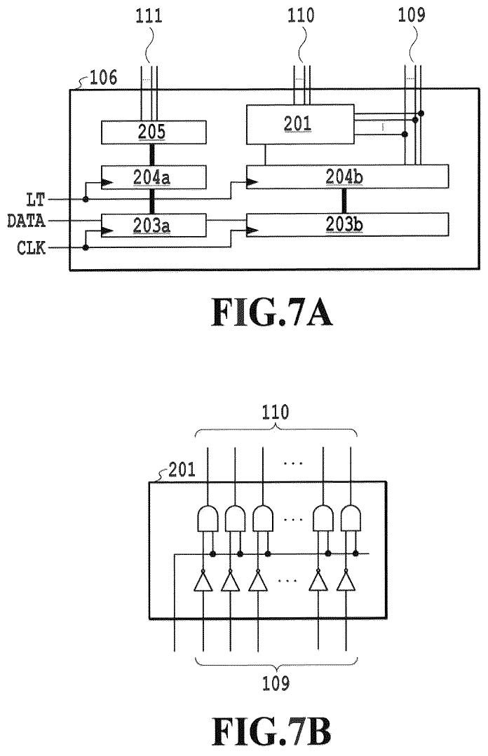

In addition, a clock signal, a data signal, and a latch signal are sent from the controller 101. The clock signal is input through a clock signal line CLK. The clock signal line CLK transfers selection information for selecting each of the ejection modules 104 and the circulation modules 105 to a first shift register 203a and a second shift register 203b (see FIG. 7A) in the form of serial data. The data signal is input into the control-data supply circuit 106 through a data signal line DATA. The latch signal is input into the control-data supply circuit 106 through a latch signal line LT. The latch signal line LT retains selection information.

The power circuit 102 is capable of supplying electric power to the ejection modules 104 and the circulation modules 105. The element substrate 18 includes a ground wiring line GNDH and a first power supply wiring line VH for receiving the electric power supplied from the power circuit 102. The ejection modules 104 and the circulation modules 105 are supplied with electric power of the same voltage (e.g., 24 V) through the first power supply wiring line VH.

In order to further reduce fluctuations in ejection energy due to the voltage drops when the plurality of heaters are driven simultaneously, the ejection modules 104 and the circulation modules 105 may be individually supplied with the electric power from the power circuit 102. In this case, supply wiring lines and an external connection terminal for a power supply voltage and a ground potential for the ejection modules 104 and supply wiring lines and an external connection terminal for a power supply voltage and a ground potential for the circulation modules 105 are separately provided to the element substrate 18.

In general, drive circuits operate at a voltage higher than logic circuits. For this reason, a substrate on which high-voltage-proof transistors and normal transistors are mounted together is used. In the present embodiment, the ejection driving elements MD1 and the circulation driving elements MD2 include Double-diffused MOSFET (DMOS) transistors, which are high-voltage-proof transistors.

The current to drive the circulation heaters RhB generates thermal energy that circulates the liquid in the individual channels 23 (see FIG. 4A, etc.). In the case where the current to drive the circulation heaters RhB is smaller than the current to drive the ejection heaters RhA, the current driving capability of the DMOS transistors may be relatively low. The area of each circulation driving element MD2 is preferably smaller than the area of the ejection driving element MD1.

FIG. 7A is a schematic diagram of the control-data supply circuit 106 that is applicable to the present embodiment.

As illustrated in FIG. 7A, the control-data supply circuit 106 includes a decoder circuit 205 connected to the time-sharing selection signal lines 111, a first latch circuit 204a connected to the decoder circuit 205, and the first shift register 203a connected to the first latch circuit 204a.

The control-data supply circuit 106 includes a circulation-group selection circuit 201 connected to the circulation-group selection signal lines 110 and a second latch circuit 204b connected to the ejection-group selection signal lines 109. The control-data supply circuit 106 includes the second shift register 203b connected to the second latch circuit 204b and external input terminals for receiving the clock signal, the data signal, and the latch signal.

In the control-data supply circuit 106, logic circuits each include low-voltage-proof MOS transistors. For example, the circulation-group selection circuit 201, the first shift register 203a, the second shift register 203b, the first latch circuit 204a, the second latch circuit 204b, the decoder circuit 205, and the like each include low-voltage-proof MOS transistors. The first logic circuits AND1 and the second logic circuits AND2 (see FIG. 6) each also include low-voltage-proof MOS transistors.

FIG. 7B is a schematic diagram of the circulation-group selection circuit 201 that is applicable to the present embodiment.

As illustrated in FIG. 7B, the circulation-group selection circuit 201 includes the ejection-group selection signal lines 109 and the circulation-group selection signal lines 110.

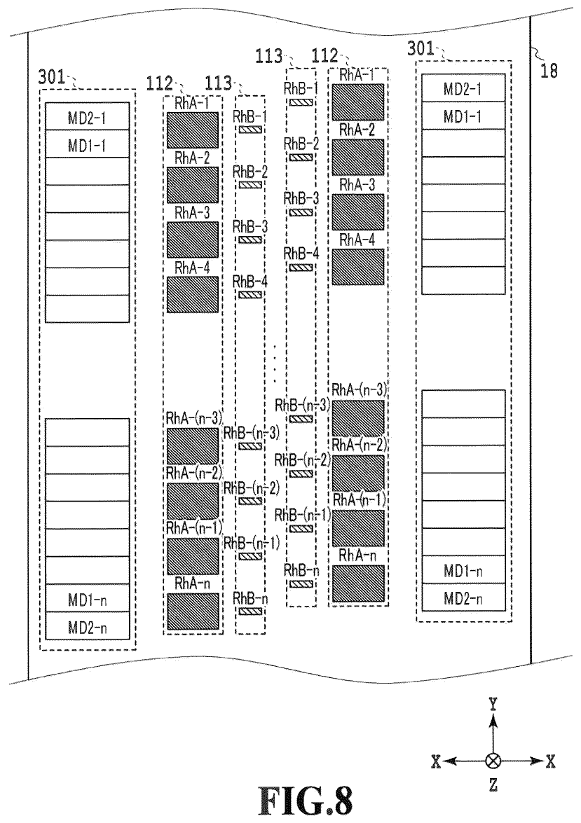

FIG. 8 is a schematic diagram illustrating the arrangement on the element substrate 18 that is applicable to the present embodiment.

As illustrated in FIG. 8, the element substrate 18 includes the multiple ejection heaters RhA, the multiple circulation heaters RhB, the multiple ejection driving elements MD1, and the multiple circulation driving elements MD2. The multiple ejection heater arrays 112 and the multiple circulation heater arrays 113 are formed along a direction in which the long sides of the element substrate 18 extend (the Y-direction).

Specifically, the multiple ejection heaters RhA include a first ejection heater RhA-1, a second ejection heater RhA-2, a third ejection heater RhA-3, and a fourth ejection heater RhA-4. In the case where it is not necessary to particulaRly differentiate the first ejection heater RhA-1, the second ejection heater RhA-2, the third ejection heater RhA-3, and the fourth ejection heater RhA-4 from one another, they will be hereinafter referred to as the ejection heaters RhA.

The multiple circulation heaters RhB include a first circulation heater RhB-1, a second circulation heater RhB-2, a third circulation heater RhB-3, and a fourth circulation heater RhB-4. In the case where it is not necessary to particularly differentiate the first circulation heater RhB-1, the second circulation heater RhB-2, the third circulation heater RhB-3, and the fourth circulation heater RhB-4 from one another, they will be hereinafter referred to as the circulation heaters RhB.

The multiple ejection driving elements MD1 and the multiple circulation driving elements MD2 are alternately arranged along the Y-direction. The multiple ejection driving elements MD1 and the multiple circulation driving elements MD2 alternately arranged in lines along the Y-direction form driving element arrays 301.

The ejection heaters RhA and the circulation heaters RhB contain an electric resistance material as their major components. For example, the ejection heaters RhA and the circulation heaters RhB contain tantalum silicon nitride, tungsten silicon nitride, or the like as the electric resistance material.

The ejection driving elements MD1 and the circulation driving elements MD2 are provided in the same semiconductor layer. For both the ejection driving elements MD1 and the circulation driving elements MD2, N-type field-effect transistors can be used. Note that the example of the arrangement of the multiple ejection heater arrays 112 and the multiple circulation heater arrays 113 illustrated in FIG. 8 may be reversed. That is, two ejection heater arrays 112 may be arranged between two circulation heater arrays 113.

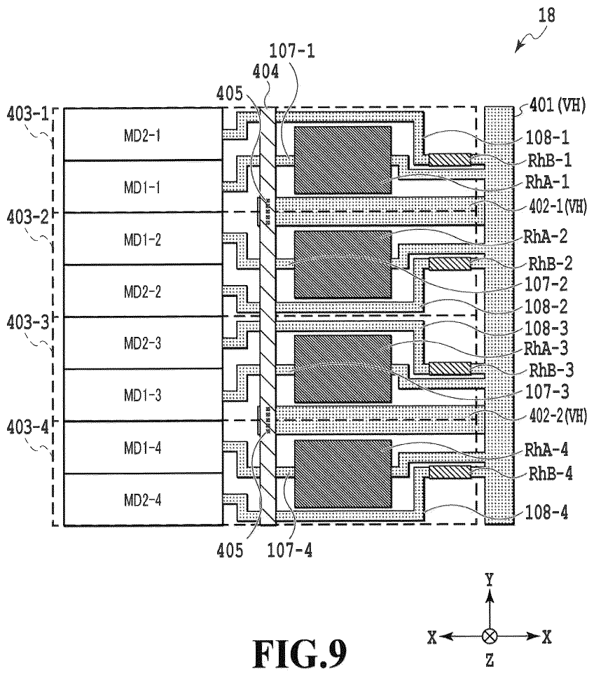

FIG. 9 is a schematic enlarged view illustrating a part of the wiring configuration of the element substrate 18.

As illustrated in FIG. 9, the element substrate 18 includes a first unit 403-1 including a plurality of electric members and a second unit 403-2 including a plurality of electric members.

The first unit 403-1 includes the first ejection heater RhA-1 that generates energy for ejecting liquid and the first circulation heater RhB-1 that generates energy for circulating liquid. The first unit 403-1 includes a first ejection driving element MD1-1 that drives the first ejection heater RhA-1 and a first circulation driving element MD2-1 that drives the first circulation heater RhB-1. The first unit 403-1 includes a first ejection wiring line 107-1 that connects the first ejection heater RhA-1 and the first ejection driving element MD1-1 and a first circulation wiring line 108-1 that connects the first circulation heater RhB-1 and the first circulation driving element MD2-1.

In the case where it is not necessary to particularly differentiate the first ejection wiring line 107-1, a second ejection wiring line 107-2, a third ejection wiring line 107-3, and a fourth ejection wiring line 107-4 from one another, they will be hereinafter referred to as ejection wiring lines 107. In the case where it is not necessary to particularly differentiate the first circulation wiring line 108-1, a second circulation wiring line 108-2, a third circulation wiring line 108-3, and a fourth circulation wiring line 108-4 from one another, they will be hereinafter referred to as circulation wiring lines 108.

The second unit 403-2 includes the second ejection heater RhA-2 that generates energy for ejecting liquid and the second circulation heater RhB-2 that generates energy for circulating liquid. The second unit 403-2 includes a second ejection driving element MD1-2 that drives the second ejection heater RhA-2 and a second circulation driving element MD2-2 that drives the second circulation heater RhB-2. The second unit 403-2 includes the second ejection wiring line 107-2 that connects the second ejection heater RhA-2 and the second ejection driving element MD1-2 and the second circulation wiring line 108-2 that connects the second circulation heater RhB-2 and the second circulation driving element MD2-2.

The element substrate 18 includes the first power supply wiring line VH that supplies the electric power to the first ejection heater RhA-1, the first circulation heater RhB-1, the second ejection heater RhA-2, and the second circulation heater RhB-2 (see FIG. 6). The first power supply wiring line VH includes a first extension part 402-1 that extends between the first ejection heater RhA-1 and the second ejection heater RhA-2. In the case where it is not necessary to particulaRly differentiate the first extension part 402-1 and a second extension part 402-2 from each other, they will be hereinafter referred to as extension parts 402.

The first unit 403-1 and the second unit 403-2 are arranged symmetrically with respect to the first extension part 402-1. Specifically, the first extension part 402-1 is positioned on a boundary line between the first unit 403-1 and the second unit 403-2. The first unit 403-1 and the second unit 403-2 are arranged symmetrically with respect to the boundary line between the first unit 403-1 and the second unit 403-2.

The first power supply wiring line VH also includes a longitudinal part 401 that extends along a long side of the element substrate 18. The multiple ejection heaters RhA and the multiple circulation heaters RhB are connected to the longitudinal part 401 of the first power supply wiring line VH and are supplied with the electric power from the first power supply wiring line VH.

The element substrate 18 also includes a second power supply wiring line 404 that extends along a long side of the element substrate 18. The proximal end portion of the first extension part 402-1 is connected to the longitudinal part 401. The distal end portion of the first extension part 402-1 is connected to the second power supply wiring line 404 via a conductive plug 405. The conductive plug 405 contains a metallic material as its major component. Examples of a material of the conductive plug 405 include tungsten or copper.

In a posture in which the liquid ejection head 1 (see FIG. 1) is used, the element substrate 18 is formed by laminating a first layer, an insulation layer, and a second layer in this order from below along the Z-direction in the present embodiment. The first layer and the second layer contain a metal as their major components. For example, the first layer and the second layer are made of aluminum or copper. The first layer (a backmost layer in FIG. 9) includes the first extension part 402-1, the longitudinal part 401, the ejection wiring lines 107, and the circulation wiring lines 108. The insulation layer includes the conductive plug 405. The second layer (a frontmost layer in FIG. 9) includes the second power supply wiring line 404.

The element substrate 18 includes the first unit 403-1, the second unit 403-2, a third unit 403-3, and a fourth unit 403-4 that are arranged continuously in the Y-direction. The third unit 403-3 and the fourth unit 403-4 each include a plurality of electric members as with the first unit 403-1 and the second unit 403-2.

The third unit 403-3 includes the third ejection heater RhA-3 that generates energy for ejecting liquid and the third circulation heater RhB-3 that generates energy for circulating liquid. The third unit 403-3 includes a third ejection driving element MD1-3 that drives the third ejection heater RhA-3 and a third circulation driving element MD2-3 that drives the third circulation heater RhB-3. The third unit 403-3 includes the third ejection wiring line 107-3 that connects the third ejection heater RhA-3 and the third ejection driving element MD1-3 and the third circulation wiring line 108-3 that connects the third circulation heater RhB-3 and the third circulation driving element MD2-3.

The fourth unit 403-4 includes the fourth ejection heater RhA-4 that generates energy for ejecting liquid and the fourth circulation heater RhB-4 that generates energy for circulating liquid. The fourth unit 403-4 includes a fourth ejection driving element MD1-4 that drives the fourth ejection heater RhA-4 and a fourth circulation driving element MD2-4 that drives the fourth circulation heater RhB-4. The fourth unit 403-4 includes the fourth ejection wiring line 107-4 that connects the fourth ejection heater RhA-4 and the fourth ejection driving element MD1-4 and the fourth circulation wiring line 108-4 that connects the fourth circulation heater RhB-4 and the fourth circulation driving element MD2-4.

The element substrate 18 includes the first power supply wiring line VH that supplies the electric power to the third ejection heater RhA-3, the third circulation heater RhB-3, the fourth ejection heater RhA-4, and the fourth circulation heater RhB-4 (see FIG. 6). The first power supply wiring line VH includes a second extension part 402-2 that extends between the third ejection heater RhA-3 and the fourth ejection heater RhA-4.

The third unit 403-3 and the fourth unit 403-4 are arranged symmetrically with respect to the second extension part 402-2. Specifically, the second extension part 402-2 is positioned on a boundary line between the third unit 403-3 and the fourth unit 403-4. The third unit 403-3 and the fourth unit 403-4 are arranged symmetrically with respect to the boundary line between the third unit 403-3 and the fourth unit 403-4.

The first power supply wiring line VH can supply the electric power to the third ejection heater RhA-3 and the fourth ejection heater RhA-4 with the longitudinal part 401 and portions that extend along a direction intersecting the longitudinal part 401. The above configuration can provide a region to arrange the first extension part 402-1 with a relatively large width (length in the Y-direction) between the first ejection heater RhA-1 and the second ejection heater RhA-2.

The above configuration can further provide a region to arrange the second extension part 402-2 with a relatively large width (length in the Y-direction) between the third ejection heater RhA-3 and the fourth ejection heater RhA-4.

Between the second ejection heater RhA-2 and the third ejection heater RhA-3, the second circulation wiring line 108-2 and the third circulation wiring line 108-3 need to be arranged. The widths (lengths in the Y-direction) of the second circulation wiring line 108-2 and the third circulation wiring line 108-3 are smaller than the width (length in the Y-direction) of each extension part 402. Therefore, it is completely feasible to arrange the two circulation wiring lines 108 between the two ejection heaters RhA. Note that the arrangement of the multiple ejection heaters RhA and the multiple circulation heaters RhB may be reversed.

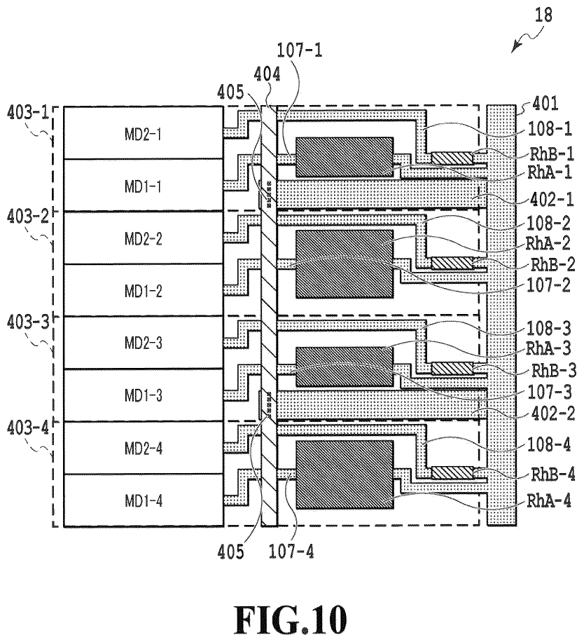

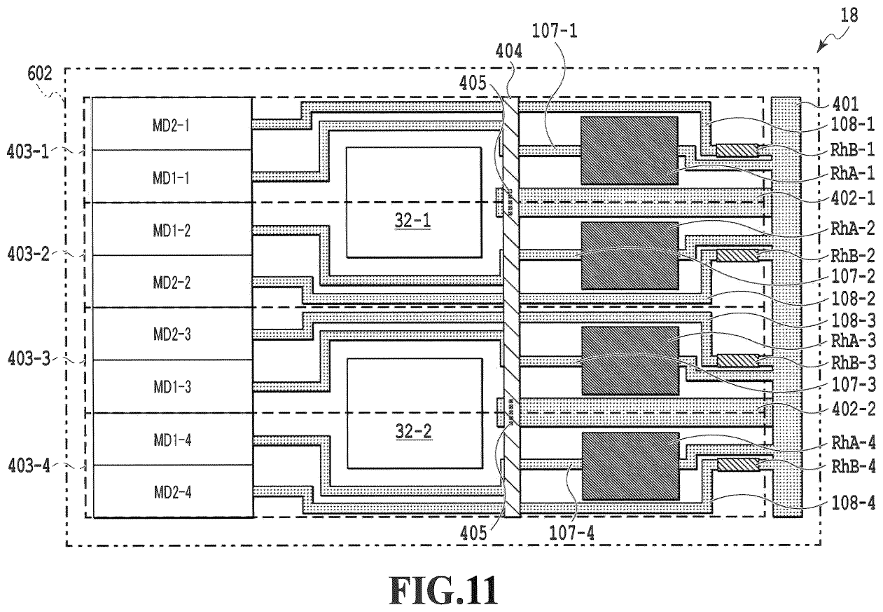

FIG. 10 is a diagram illustrating a comparative example of the wiring configuration of the element substrate 18 relative to the present embodiment.

As illustrated in FIG. 10, the first unit 403-1 and the second unit 403-2 are arranged in the same orientation. In this manner, the first unit 403-1 and the second unit 403-2 are arranged not symmetrically with respect to the first extension part 402-1 in this comparative example. Likewise, the third unit 403-3 and the fourth unit 403-4 are arranged in the same orientation, not symmetrically with respect to the second extension part 402-2.

In the element substrate 18 in FIG. 10, two adjacent ejection heaters RhA have different lengths in the Y-direction so that the element substrate 18 in FIG. 10 has the same size in the Y-direction as that of the element substrate 18 in FIG. 9. The length in the Y-direction of one of the ejection heaters RhA of two types is the same as the length in the Y-direction of each ejection heater RhA used in the example in FIG. 9, while the length in the Y-direction of the other ejection heater RhA is shorter than the length in the Y-direction of the ejection heater RhA used in the example in FIG. 9.

In other words, if all of the ejection heaters RhA in this comparative example are made to have the same size as the ejection heaters RhA in FIG. 9, the length in the Y-direction of the entire element substrate 18 increases. As seen from the above, it is difficult in the comparative example to arrange two ejection heaters RhA having a relatively large width (length in the Y-direction) continuously in the Y-direction. Furthermore, the use of ejection heaters RhA of the two types with different sizes complicates the control because each ejection heater RhA has a different heat generation amount.

In addition, in this comparative example, it is difficult to meet a request for arranging a plurality of relatively thin wiring lines (e.g., an ejection wiring line 107, a circulation wiring line 108, or both of them, etc.) between two ejection heaters RhA.

In contrast, in the element substrate 18 of the present embodiment, the two units are arranged so as to have line symmetry. As a result, spaces for continuously arranging the ejection heaters RhA having a desired size along a predetermined direction are provided. In addition, the arrangement of the ejection heaters RhA (printing elements) having a desired size in the spaces provided in this manner enables the printing element substrate 3 to be manufactured without leading to an increase in the size of the element substrate 18.

Therefore, the technique according to the present embodiment enables the provision of the printing element substrate on which the printing elements, the circulation elements, and the wiring lines are arranged efficiently.

### Second Embodiment

In the following, the description of the same component as in the first embodiment or a component corresponding to that in the first embodiment will be omitted, and differences from the first embodiment will be described.

FIG. 11 is a schematic enlarged view illustrating a part of the wiring configuration of an element substrate 18 that is applicable to a second embodiment.

As illustrated in FIG. 11, the element substrate 18 of the present embodiment includes a ninth unit 602 including a plurality of units. The ninth unit 602 includes a first unit 403-1, a second unit 403-2, a third unit 403-3, and a fourth unit 403-4.

In the present embodiment, one of two second supply ports 32 will be referred to as a second supply port 32-1, and the other second supply port 32 will be referred to as a second supply port 32-2, for convenience of description.

The second supply port 32-1 is provided extending over the first unit 403-1 and the second unit 403-2. The second supply port 32-1 is positioned roughly at the center in the X-direction of the region that includes the first unit 403-1 and the second unit 403-2. A first ejection wiring line 107-1 and a second ejection wiring line 107-2 are provided bypassing the second supply port 32-1. The second supply port 32-1 is positioned between the first ejection wiring line 107-1 and the second ejection wiring line 107-2 in the Y-direction.

The second supply port 32-2 is provided extending over the third unit 403-3 and the fourth unit 403-4. The second supply port 32-2 is positioned roughly at the center in the X-direction of the region that includes the third unit 403-3 and the fourth unit 403-4. The third ejection wiring line 107-3 and the fourth ejection wiring line 107-4 are provided bypassing the second supply port 32-2. The second supply port 32-2 is positioned between the third ejection wiring line 107-3 and the fourth ejection wiring line 107-4 in the Y-direction.

Such a configuration can also produce the same effects as in the first embodiment.

### Third Embodiment

In the following, the description of the same component as in the first and second embodiments or a component corresponding to that in the first and second embodiments will be omitted, and differences from the first and second embodiments will be described.

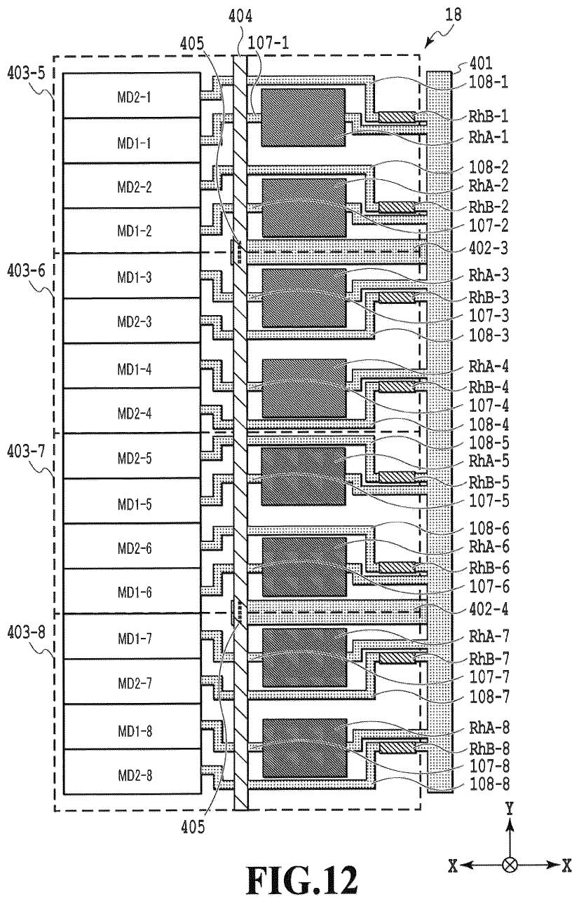

FIG. 12 is a schematic enlarged view illustrating a part of the wiring configuration of an element substrate 18 that is applicable to a third embodiment.

As illustrated in FIG. 12, the element substrate 18 of the present embodiment includes a fifth unit 403-5, a sixth unit 403-6, a seventh unit 403-7, and an eighth unit 403-8. The fifth unit 403-5, the sixth unit 403-6, the seventh unit 403-7, and the eighth unit 403-8 are arranged in this order along the Y-direction.

The fifth unit 403-5 includes a first circulation driving element MD2-1, a first ejection driving element MD1-1, a second circulation driving element MD2-2, and a second ejection driving element MD1-2. The fifth unit 403-5 includes a first ejection heater RhA-1, a second ejection heater RhA-2, a first circulation heater RhB-1, and a second circulation heater RhB-2.

The fifth unit 403-5 includes a first circulation wiring line 108-1 that connects the first circulation driving element MD2-1 and the first circulation heater RhB-1. The fifth unit 403-5 includes a first ejection wiring line 107-1 that connects the first ejection driving element MD1-1 and the first ejection heater RhA-1.

The fifth unit 403-5 includes a second circulation wiring line 108-2 that connects the second circulation driving element MD2-2 and the second circulation heater RhB-2. The fifth unit 403-5 includes a second ejection wiring line 107-2 that connects the second ejection driving element MD1-2 and the second ejection heater RhA-2.

The sixth unit 403-6 includes a third ejection driving element MDI-3, a third circulation driving element MD2-3, a fourth ejection driving element MD1-4, and a fourth circulation driving element MD2-4. The sixth unit 403-6 includes a third ejection heater RhA-3, a fourth ejection heater RhA-4, a third circulation heater RhB-3, and a fourth circulation heater RhB-4.

The sixth unit 403-6 includes a third ejection wiring line 107-3 that connects the third ejection driving element MD1-3 and the third ejection heater RhA-3. The sixth unit 403-6 includes a third circulation wiring line 108-3 that connects the third circulation driving element MD2-3 and the third circulation heater RhB-3.

The sixth unit 403-6 includes a fourth ejection wiring line 107-4 that connects the fourth ejection driving element MD1-4 and the fourth ejection heater RhA-4. The sixth unit 403-6 includes a fourth circulation wiring line 108-4 that connects the fourth circulation driving element MD2-4 and the fourth circulation heater RhB-4.

The seventh unit 403-7 includes a fifth circulation driving element MD2-5, a fifth ejection driving element MD1-5, a sixth circulation driving element MD2-6, and a sixth ejection driving element MD1-6. The seventh unit 403-7 includes a fifth ejection heater RhA-5, a sixth ejection heater RhA-6, a fifth circulation heater RhB-5, and a sixth circulation heater RhB-6.

The seventh unit 403-7 includes a fifth circulation wiring line 108-5 that connects the fifth circulation driving element MD2-5 and the fifth circulation heater RhB-5. The seventh unit 403-7 includes a fifth ejection wiring line 107-5 that connects the fifth ejection driving element MD1-5 and the fifth ejection heater RhA-5.

The seventh unit 403-7 includes a sixth circulation wiring line 108-6 that connects the sixth circulation driving element MD2-6 and the sixth circulation heater RhB-6. The seventh unit 403-7 includes a sixth ejection wiring line 107-6 that connects the sixth ejection driving element MD1-6 and the sixth ejection heater RhA-6.

The eighth unit 403-8 includes a seventh ejection driving element MD1-7, a seventh circulation driving element MD2-7, an eighth ejection driving element MD1-8, and an eighth circulation driving element MD2-8. The eighth unit 403-8 includes a seventh ejection heater RhA-7, an eighth ejection heater RhA-8, a seventh circulation heater RhB-7, and an eighth circulation heater RhB-8.

The eighth unit 403-8 includes a seventh ejection wiring line 107-7 that connects the seventh ejection driving element MD1-7 and the seventh ejection heater RhA-7. The eighth unit 403-8 includes a seventh circulation wiring line 108-7 that connects the seventh circulation driving element MD2-7 and the seventh circulation heater RhB-7.

The eighth unit 403-8 includes an eighth ejection wiring line 107-8 that connects the eighth ejection driving element MD1-8 and the eighth ejection heater RhA-8. The eighth unit 403-8 includes an eighth circulation wiring line 108-8 that connects the eighth circulation driving element MD2-8 and the eighth circulation heater RhB-8.

In the present embodiment, between the second ejection heater RhA-2 and the third ejection heater RhA-3, a third extension part 402-3 is provided. In the case where it is not necessary to particulaRly differentiate the third extension part 402-3 and a fourth extension part 402-4 from each other, they will be hereinafter referred to as extension parts 402.

The third extension part 402-3 extends in the X-direction, along a short side of the element substrate 18. One end of the third extension part 402-3 is connected to a second power supply wiring line 404 via a conductive plug 405. The other end of the third extension part 402-3 is connected to a longitudinal part 401 of the first power supply wiring line VH.

The members constituting the fifth unit 403-5 and the members constituting the sixth unit 403-6 are arranged symmetrically with respect to the third extension part 402-3. Between the sixth ejection heater RhA-6 and the seventh ejection heater RhA-7, the fourth extension part 402-4 is provided.

The fourth extension part 402-4 extends in the X-direction, along a short side of the element substrate 18. One end of the fourth extension part 402-4 is connected to the second power supply wiring line 404 via a conductive plug 405. The other end of the fourth extension part 402-4 is connected to the longitudinal part 401 of the first power supply wiring line VH. The members constituting the seventh unit 403-7 and the members constituting the eighth unit 403-8 are arranged symmetrically with respect to the fourth extension part 402-4. The third extension part 402-3 and the fourth extension part 402-4 contain a metallic material (e.g., aluminum, copper, etc.) as their major component.

Such a configuration can also produce the same effects as in the first embodiment

Note that although each unit of the present embodiment includes two ejection heaters, two circulation heaters, and two sets of drain wiring lines of the two types, these numbers may be three or more.

### Fourth Embodiment

In the following, the description of the same component as in the first to third embodiments or a component corresponding to that in the first to third embodiments will be omitted, and differences from the first to third embodiments will be described.

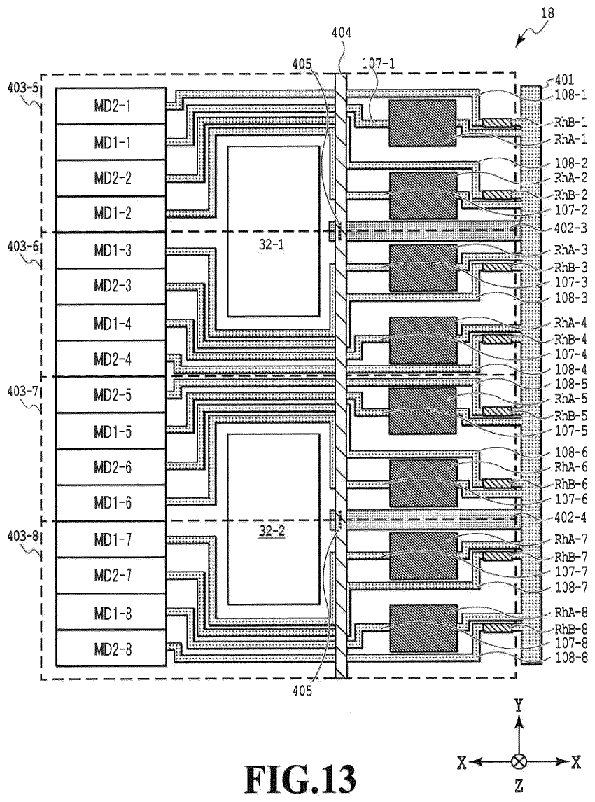

FIG. 13 is a schematic enlarged view illustrating a part of the wiring configuration of an element substrate 18 that is applicable to a fourth embodiment.

As illustrated in FIG. 13, in the element substrate 18 of the present embodiment, a second supply port 32-1 is formed between a second ejection wiring line 107-2 and a third ejection wiring line 107-3. In addition, a second supply port 32-2 is formed between a sixth ejection wiring line 107-6 and a seventh ejection wiring line 107-7.

Such a configuration can also produce the same effects as in the first embodiment.

### Fifth Embodiment

In the following, the description of the same component as in the first to fourth embodiments or a component corresponding to that in the first to fourth embodiments will be omitted, and differences from the first to fourth embodiments will be described.

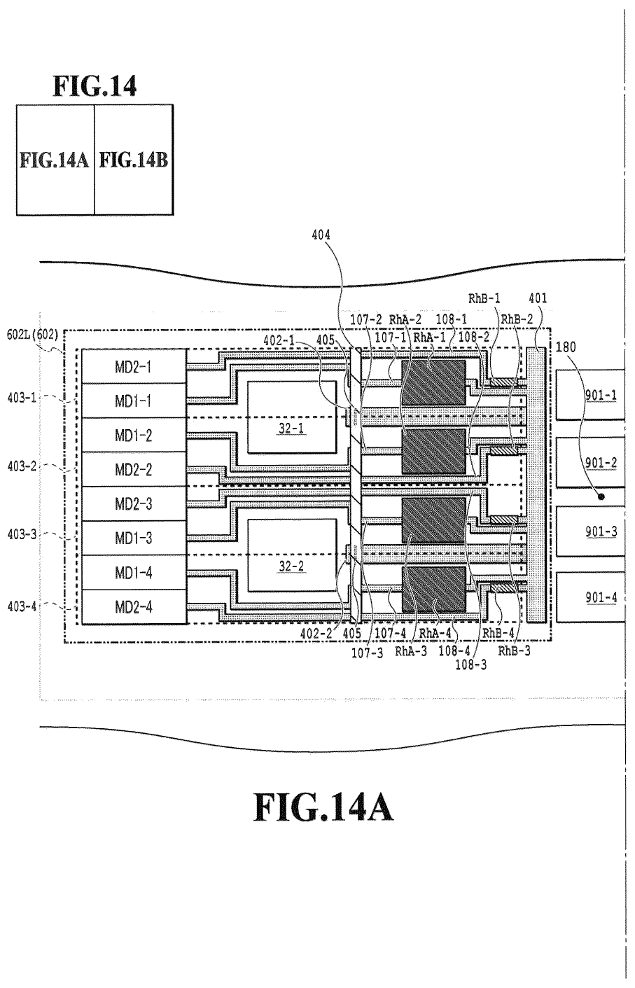

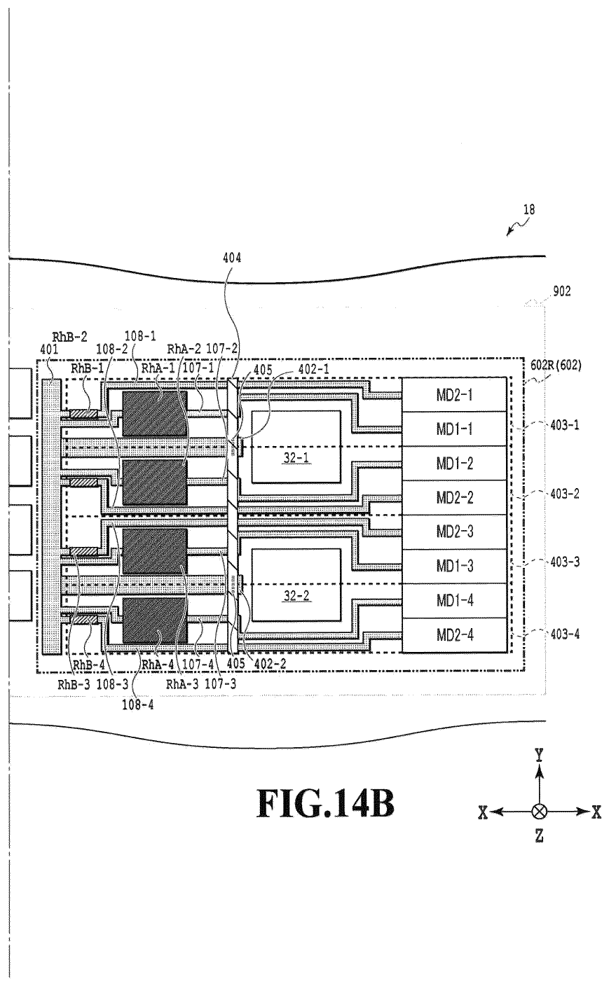

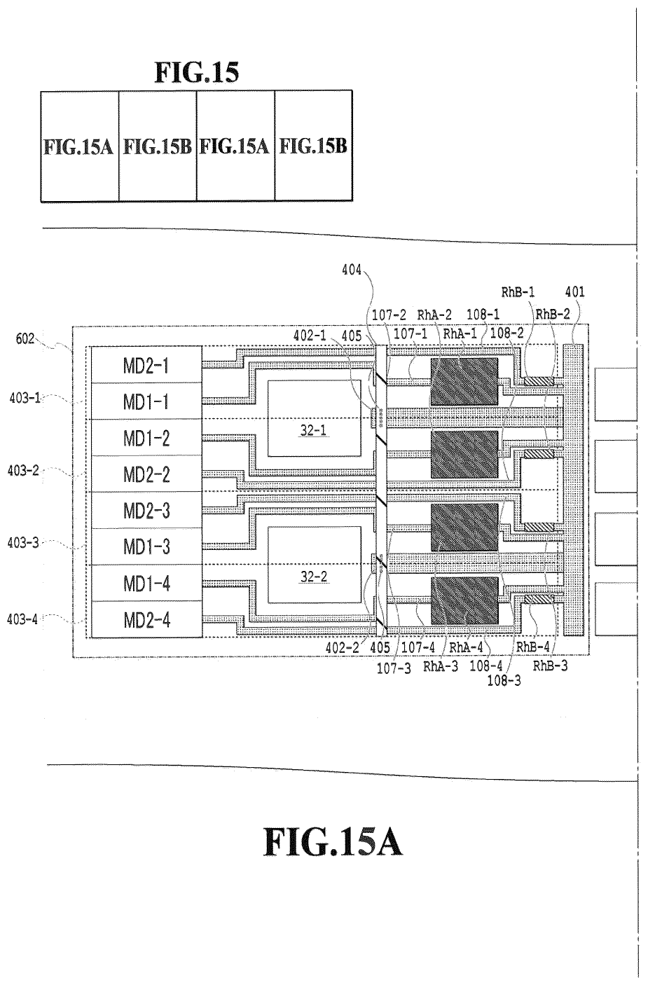

FIG. 14 is a schematic enlarged view illustrating a part of the wiring configuration of an element substrate 18 that is applicable to a fifth embodiment.

As illustrated in FIG. 14, the element substrate 18 of the present embodiment includes a tenth unit 902 that includes two ninth units 602. Hereinafter, one of the two ninth units 602 will be referred to as a “ninth unit 602L,” and the other ninth unit 602 will be referred to as a “ninth unit 602R” for convenience of description.

In the element substrate 18 of the present embodiment, a plurality (four in the present embodiment) of supply ports 901 supplying liquid to the ninth units 602 are formed along a direction in which a long side of the element substrate 18 extends (the Y-direction) at the center of the element substrate 18 in a direction in which a short side of the element substrate 18 extends (the X-direction).

Hereinafter, in plain view of the element substrate 18, the four supply ports 901 will be referred to, from top to bottom, as a “supply port 901-1,” a “supply port 901-2,” a “supply port 901-3,” and a “supply port 901-4,” for convenience of description. The supply port 901-1, the supply port 901-2, the supply port 901-3, and the supply port 901-4 supply liquid to the ninth unit 602L and the ninth unit 602R.

This configuration enables the supply of the liquid to the ninth unit 602L and the ninth unit 602R using one supply port array constituted by the plurality of supply ports formed along the Y-direction.

Therefore, the element substrate 18 can be downsized in the X-direction compared with the configuration in which two supply port arrays including a supply port array to supply the liquid to only the ninth unit 602L and a supply port array to supply the liquid to only the ninth unit 602R are formed in the X-direction.

The ninth unit 602L and the ninth unit 602R are arranged symmetrically with respect to a center point 180 of the tenth unit 902. Note that the center point 180 in FIG. 14 is an imaginary point. This configuration can balance the heat generation between the left and right sides of the element substrate 18.

Therefore, the printing element substrate according to the present embodiment enables the printing elements, the circulation elements, and the wiring lines to be arranged efficiently while balancing the heat generation.

### Sixth Embodiment

In the following, the description of the same component as in the first to fifth embodiments or a component corresponding to that in the first to fifth embodiments will be omitted, and differences from the first to fifth embodiments will be described.

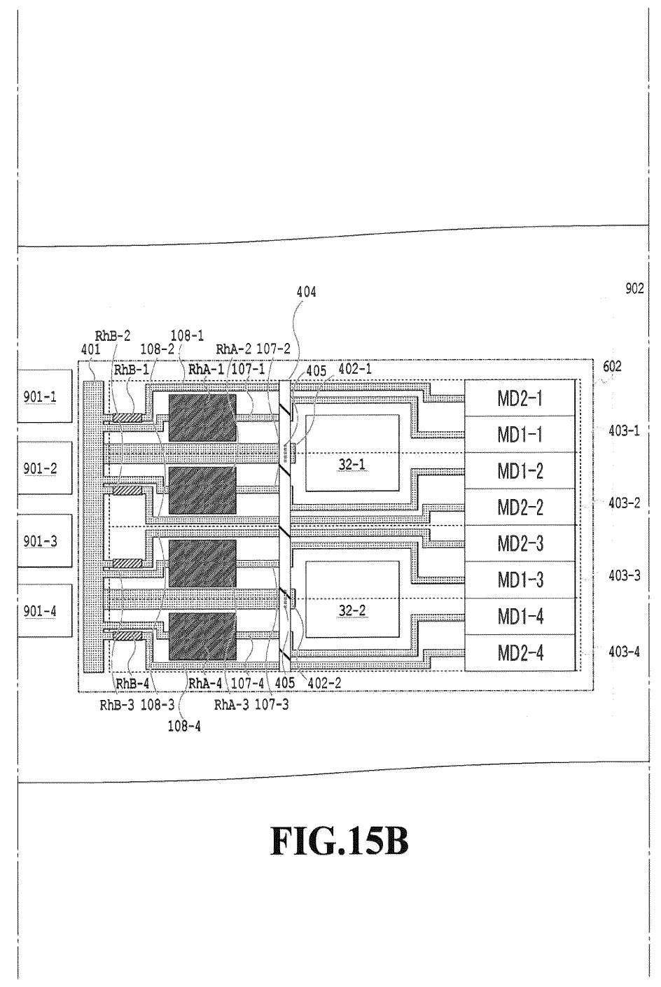

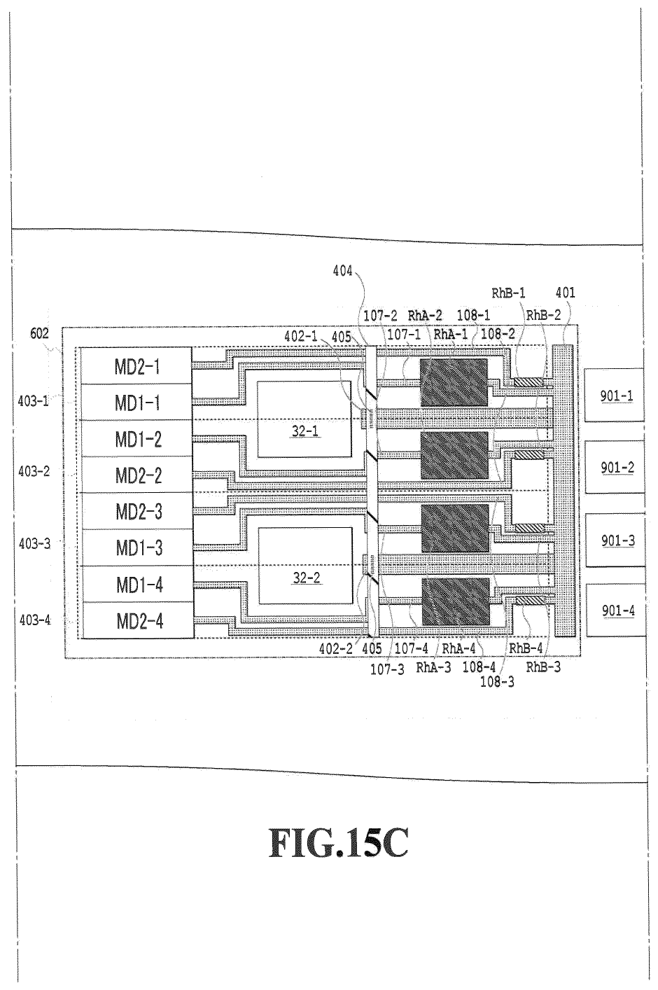

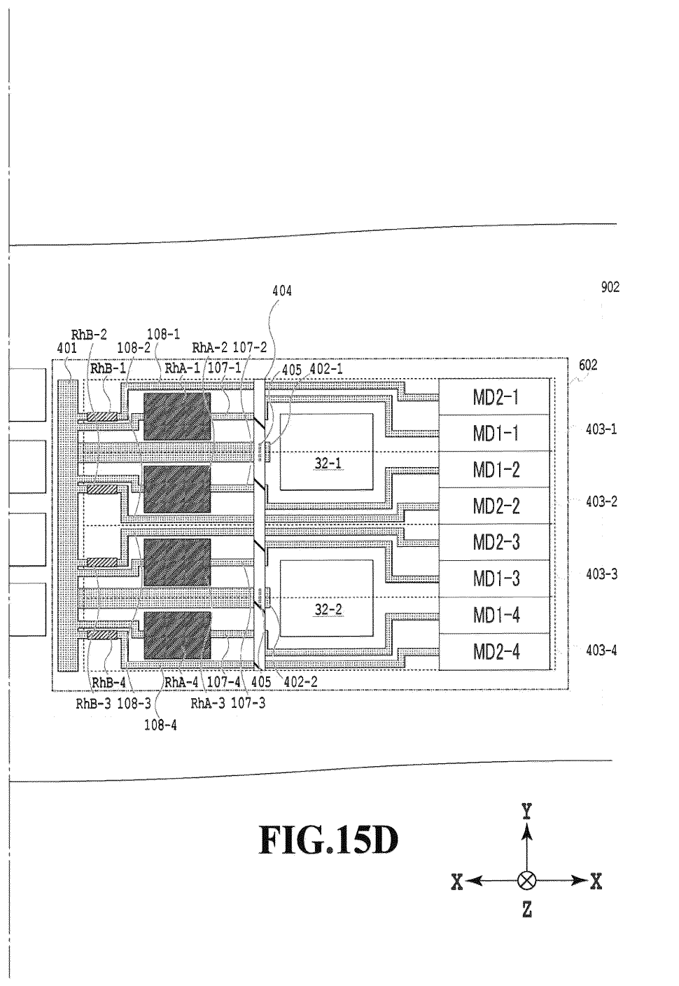

FIG. 15 is a schematic enlarged view illustrating a part of the wiring configuration of an element substrate 18 that is applicable to a sixth embodiment.

As illustrated in FIG. 15, in the element substrate 18 of the present embodiment, two tenth units 902 are arranged in the X-direction. Note that three or more tenth units 902 may be arranged in the X-direction.

Such a configuration can also produce the same effects as in the fifth embodiment.

### Seventh Embodiment

In the following, the description of the same component as in the first to sixth embodiments or a component corresponding to that in the first to sixth embodiments will be omitted, and differences from the first to sixth embodiments will be described.

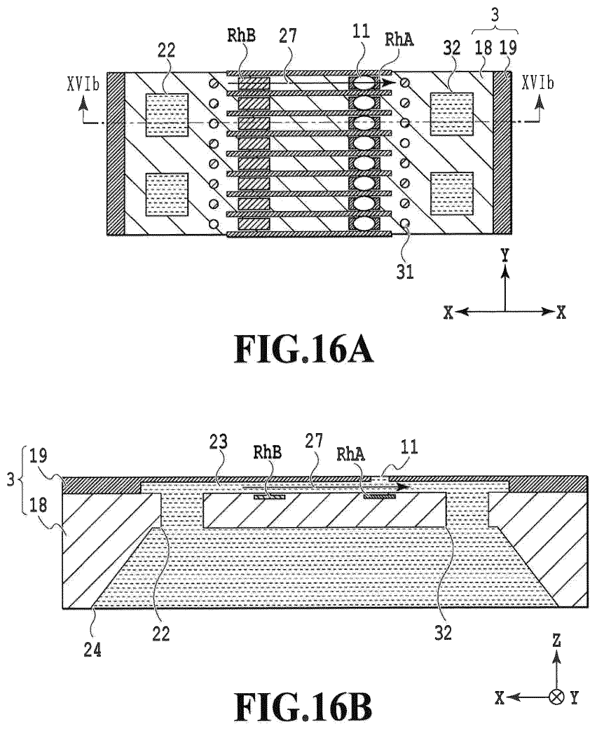

FIG. 16A is a plan view of the configuration of channels in a printing element substrate 3 that is applicable to the present embodiment, as viewed along a direction in which droplets are ejected.

FIG. 16B is a cross-sectional view taken along a XVIb-XVIb line in FIG. 16A. As illustrated in FIG. 16B, individual channels 23 of the straight type are also formed in the present embodiment. In the example in FIG. 3B, the element substrate 18 is formed with the channel extending parallel to the Z-direction. In contrast, as illustrated in FIG. 16B, a channel spreading out as the channel extends in a direction away from ejection ports 11 may be formed in the element substrate 18. This configuration also produces the same effects as in the first embodiment.

### Eighth Embodiment

In the following, the description of the same component as in the first to seventh embodiments or a component corresponding to that in the first to seventh embodiments will be omitted, and differences from the first to seventh embodiments will be described.

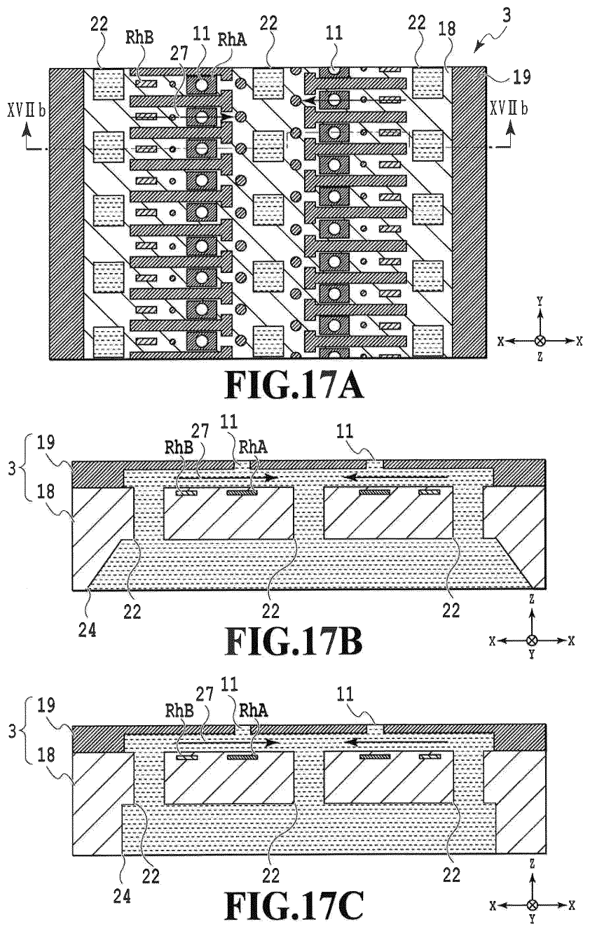

FIG. 17A is a schematic plan view of the configuration of channels in a printing element substrate 3 that is applicable to the present embodiment, as viewed along a direction in which droplets are ejected.

As illustrated in FIG. 17A, in the present embodiment, a plurality of first supply ports 22 are formed in the X-direction. Note that although three first supply ports 22 are formed along the X-direction in the present embodiment, four or more first supply ports 22 may be formed.

In addition, a plurality of ejection ports 11 are formed along the X-direction. Along the X-direction, a plurality of ejection port arrays each extending in the Y-direction are formed along the X-direction. In this manner, in the present embodiment, the number of the first supply ports 22 in the X-direction and the number of the ejection ports 11 in the X-direction are increased compared with the first embodiment.

In the present embodiment, two ejection ports 11 arranged in the X-direction are arranged offset from each other in the Y-direction. By offsetting the ejection ports 11 included in the ejection port arrays from each other in the Y-direction in this manner, it is possible to improve the resolution of printing compared with the case where the ejection ports 11 included in the ejection port arrays illustrated in FIG. 2B are aligned in the Y-direction. However, these ejection ports 11 need not be offset in the Y-direction.

At the center in the X-direction, there are no wiring lines provided between the supply ports. This configuration improves the degrees of freedom in the size of the first supply ports 22 provided at the center in the X-direction compared with the configuration in which wiring lines are provided between the supply ports at the center in the X-direction.

Two ejection ports 11 provided in the X-direction are positioned relatively close to each of the first supply ports 22 provided at the center in the X-direction. A possible configuration is such that requires no wiring regions between openings in the ink supply port array at the center, thus increasing the degree of freedom in the size or density of the openings in the ink supply port array at the center. This enables quick refilling of the ejection ports 11 with the liquid, thus improving in the productivity of printing compared with the configuration in which the ejection ports 11 are formed relatively far from the first supply ports 22.

Note that, in the present embodiment, the positions of three first supply ports 22 formed along the X-direction are aligned in the Y-direction. The positions of the three first supply ports 22 in the Y-direction may be offset in accordance with the positions of the ejection ports 11, the layout of the wiring lines, or both of them.

FIG. 17B is a cross-sectional view taken along a XVII-XVII line in FIG. 17A.

As illustrated in FIG. 17B, the element substrate 18 of the present embodiment is formed with a channel that spreads out as the channel extends in a −Z-direction away from two ejection ports 11 formed along the X-direction.

As described above, the configuration of the present embodiment can reduce the size in the X-direction compared with the first embodiment (the configuration in which the configuration illustrated in FIG. 3 is duplicated and arranged in the X-direction). The configuration of the present embodiment can further improve the degrees of freedom in design.

FIG. 17C is a diagram illustrating a modification of the channels applicable to the present embodiment.

The channel of the element substrate 18 in FIG. 17B spreads out as the channel extends away from the ejection ports 11. In contrast, as illustrated in FIG. 17C, all of a plurality of channels formed in the element substrate 18 may extend straight along the Z-direction. Such a configuration can also produce the same effects as with the configuration in FIG. 17B.

### Ninth Embodiment

### <U-Shaped>

In the following, the description of the same component as in the first to eighth embodiments or a component corresponding to that in the first to eighth embodiments will be omitted, and differences from the first to eighth embodiments will be described.

In the above embodiments, the individual channels 23 of the straight type are provided (see FIG. 3A, etc.). U-shaped channels may be provided. A liquid ejection head 1 (see FIG. 1) including U-shaped individual channels 23 will be described below.

FIGS. 18A to 18C are schematic diagrams for describing the configuration of channels in a printing element substrate 3 that is applicable to the present embodiment. FIG. 18A is a schematic plan view of ejection ports 11 and their vicinities, FIG. 18B is a cross-sectional view taken along a line XVIIIb-XVIIIb in FIG. 18A, and FIG. 18C is an enlarged view of a focused channel out of the channels in FIG. 18A.

As illustrated in FIG. 18A, the printing element substrate 3 is formed with the individual channels 23 that are U-shaped in plain view of the printing element substrate 3 in the present embodiment.

In the present disclosure, the term “U-shaped” means that the shape of a channel including an ejection heater RhA and a circulation heater RhB is a U-shape.

In the present embodiment, the multiple U-shaped individual channels 23 are formed in the Y-direction. In each U-shaped individual channel 23, its ejection heater RhA and circulation heater RhB are arranged in the Y-direction. As a result, in the present embodiment, ejection heaters RhA and circulation heaters RhB are alternately arranged along a direction in which an ejection port array extends.

In each U-shaped individual channel 23, an end portion at which a circulatory flow 27 turns back is positioned outer than the ejection port array. In the individual channel 23, the circulatory flow 27 passes a portion where the circulation heater RhB is provided, then turns back at the end portion of the individual channel 23, and passes a portion where the ejection heater RhA is provided.

In the present embodiment, a supply groove 42 that extends in the Y-direction and supplies liquid from the element substrate 18 to an ejection port forming member 19 is formed at the center in the X-direction of the printing element substrate 3. In the ejection port forming member 19, two ejection port arrays extending in the Y-direction are formed along the X-direction. In plain view of the printing element substrate 3, one of the two ejection port arrays is formed on the left side of the supply groove 42, and the other ejection port array is formed on the right side of the supply groove 42. In this manner, the liquid is supplied from the supply groove 42 to the individual channels 23 formed on both sides of the supply groove 42 in the present embodiment.

In the printing element substrate 3, the multiple individual channels 23 are arranged along the Y-direction. The end portions of these U-shaped individual channels 23 at which circulatory flows 27 turn back are adjacent to one another along the Y-direction.

As illustrated in FIG. 18B, in the state where the element substrate 18 and the ejection port forming member 19 are bonded together, the supply groove 42 is formed penetrating the element substrate 18 in the Z-direction. The supply groove 42 gradually decreases in diameter as the supply groove 42 extends in a direction in which the liquid is supplied (the Z-direction). This configuration can provide a certain flow speed of supplying the liquid. This configuration is however not indispensable.

When the liquid is ejected from the ejection ports 11, the liquid is supplied from the supply groove 42 formed at the center in the X-direction of the element substrate 18. In the ejection port forming member 19, the individual channels 23 functioning as pressure chambers 12 are formed spreading outward from a portion through which the liquid is supplied from the supply groove 42. In each pressure chamber 12, when the liquid is circulated, flows from both ends in the X-direction to the center and flows toward the outer sides are produced. In this manner, at the center of the supply groove 42, both the inflows and outflows of the liquid occur at the same time. [0211] Note that although one supply groove 42 is formed in the present embodiment, a plurality of first supply ports 22 (see, FIG. 3A, etc.) may be formed as in the first embodiment. In this case, the first supply ports 22 are shared inside the element substrate 18 as in the first embodiment. In even such a configuration, U-shaped individual channels 23 can be formed.

With the present embodiment as described above, the ejection heaters RhA and the circulation heaters RhB can be arranged in lines along the Y-direction. It is thus possible to make the width in the X-direction of the printing element substrate shorter than that of the straight type.

### Tenth Embodiment

In the following, the description of the same component as in the first to ninth embodiments or a component corresponding to that in the first to ninth embodiments will be omitted, and differences from the first to ninth embodiments will be described.

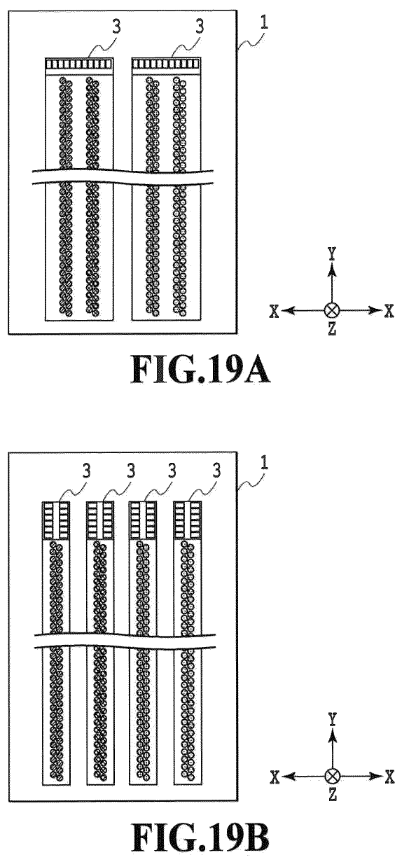

FIG. 19A and FIG. 19B are diagrams illustrating an example of a printing element substrate 3 that is applicable to the present embodiment.

In the first embodiment, one printing element substrate 3 is attached to the liquid ejection head 1 (see FIG. 2). From the one printing element substrate 3, the liquids of the four types are ejected. A plurality of printing element substrates 3 may be attached to a liquid ejection head 1. For example, as illustrated in FIG. 19A, in the case where a printing element substrate 3 is configured to eject two types of liquids, two printing element substrates 3 may be attached to the liquid ejection head 1. Such a configuration can also produce the same effects as in the first embodiment.

The use of the printing element substrate 3 of the first embodiment, a liquid ejection head 1 including one of the printing element substrates 3 of the present embodiment, and a liquid ejection head 1 including the other printing element substrate 3 can also produce the same effects as in the first embodiment. That is, two liquid ejection heads 1 may be used.

As illustrated in FIG. 19B, in the case where a printing element substrate 3 is configured to eject one type of a liquid, four printing element substrates 3 may be attached to the liquid ejection head 1. Such a configuration can also produce the same effects as in the first embodiment.

The use of four liquid ejection heads 1 including the respective four printing element substrates 3 can also produce the same effects as in the first embodiment.

Note that all the lengths (lengths in the Y-direction) of the multiple printing element substrates 3 are the same in the examples illustrated in FIG. 19A and FIG. 19B. The lengths of these printing element substrates 3 may differ.

### Eleventh Embodiment

In the following, the description of the same component as in the first to tenth embodiments or a component corresponding to that in the first to tenth embodiments will be omitted, and differences from the first to tenth embodiments will be described.

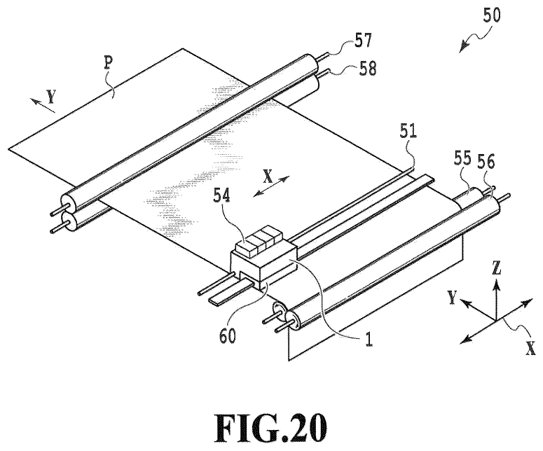

FIG. 20 is a schematic perspective view illustrating an example of a liquid ejection apparatus 50 that is applicable to the present embodiment.

In the first embodiment, the liquids are supplied from the main tanks 2 (see FIG. 1) to the sub tanks 54. Even in the case where the main tanks 2 are not provided, the technique according to the present disclosure is applicable.

As illustrated in FIG. 20, a liquid ejection apparatus 50 of the present embodiment includes ink cartridges that are configured to be attachable to or detachable from a liquid ejection head 1.

With such a configuration, when liquids inside the ink cartridges are consumed, the ink cartridges are replaced with new ink cartridges, and thus the ejection of liquids can be resumed. Note that a head cartridge into which the liquid ejection head 1 and the ink cartridges are integrated may be detachably mounted on a carriage 60. Such a configuration can also produce the same effects as in the first embodiment.

### Twelfth Embodiment

In the following, the description of the same component as in the first to eleventh embodiments or a component corresponding to that in the first to eleventh embodiments will be omitted, and differences from the first to eleventh embodiments will be described.

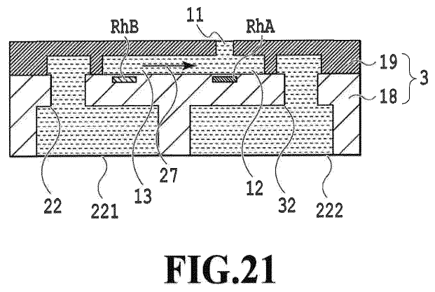

FIG. 21A is a schematic cross-sectional view for describing the configuration of a channel in a printing element substrate 3 that is applicable to the present embodiment. FIG. 21 illustrates another example of the cross-sectional view taken along the line IIIb-IIIb in FIG. 3A.

In the element substrate 18 of the first embodiment, channels positioned on the upstream sides of the first supply ports 22 and on the downstream sides of the second supply ports 32 are shared as the common channels 24. The channels on the upstream sides of the first supply ports 22 and the channels on the downstream sides of the second supply ports 32 may be individually formed. For example, as illustrated in FIG. 21, an element substrate 18 of the present embodiment is formed with first substrate channels 221 for supplying liquid to first supply ports 22 and second substrate channels 222 for collecting the liquid supplied from second supply ports 32. Such a configuration can also produce the same effects as in the first embodiment.

### Other Embodiments

The first to twelfth embodiments have been described above. Values, forms, numbers, and the like to which the technique according to the present disclosure is applicable are not limited to the examples described above. The values, forms, numbers, and the like described above may be changed as appropriate in accordance with the configuration of a printing element substrate.

The number of ejection ports constituting one ejection port array is not limited to the exemplified number. For example, the number may be an even large number such as 512. In the examples described above, two nozzle arrays are formed as nozzle arrays that can eject one type of a liquid. The number of nozzle arrays that can eject one type of a liquid may be one or may be three or more.

Note that an apparatus to which the technique according to the present disclosure is applicable is not limited to only a liquid ejection apparatus of the serial type. For example, the technique according to the present disclosure may be applied to a liquid ejection apparatus of a page-wide type, in which a line head (a page-wide-type head) being long in a page-width direction of a print medium P (the X-direction) is used to eject liquids onto print medium P being conveyed in the conveying direction for printing.

In the above embodiments, the inks are used as the liquids. However, liquids to which the technique according to the present disclosure can be used are not limited to inks. In addition to the inks, various printing liquids including a treatment liquid that is used for improving the fixing properties of an ink on a print medium, reducing glossy unevenness, and improving abrasion resistance may be used.

The technique according to the present disclosure enables the provision of the printing element substrate on which the printing elements, the circulation elements, and the wiring lines are arranged efficiently.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167592, filed Sep. 26, 2024, which is hereby incorporated by reference herein in its entirety.

What is claimed is:

1. A printing element substrate comprising:
a first unit including a first element and a second element;
a second unit including a third element and a fourth element; and
a power supply wiring line including a first portion and a second portion, the first portion supplying electric power to the first unit, the second portion supplying electric power to the second unit, wherein
the power supply wiring line includes an extension portion that extends along a boundary line between the first unit and the second unit,
the first element and the third element are arranged symmetrically with respect to the extension portion,
the second element and the fourth element are arranged symmetrically with respect to the extension portion, and
the first portion and the second portion are arranged symmetrically with respect to the extension portion.

2. The printing element substrate according to claim 1, wherein
the first element and the second element have different sizes,
the third element and the fourth element have different sizes,
the first element and the third element have the same size, and
the second element and the fourth element have the same size.

3. The printing element substrate according to claim 1, wherein
the first element and the third element are arranged along a first direction to form a first element array, the first direction intersecting the extension portion, and
the second element and the fourth element are arranged along the first direction to form a second element array.

4. The printing element substrate according to claim 1, wherein
the first element and the third element are ejection elements for ejecting a liquid,
the first unit further includes:
a first ejection driving element that drives the first element; and
a first ejection wiring line that connects the first element and the first ejection driving element,
the second unit further includes:
a second ejection driving element that drives the third element; and
a second ejection wiring line that connects the third element and the second ejection driving element,
the first ejection driving element and the second ejection driving element are arranged symmetrically with respect to the boundary line, and
the first ejection wiring line and the second ejection wiring line are arranged symmetrically with respect to the boundary line.

5. The printing element substrate according to claim 4, wherein
the second element and the fourth element are circulation elements for circulating a liquid,
the first unit further includes:
a first circulation driving element that drives the second element; and
a first circulation wiring line that connects the second element and the first circulation driving element,
the second unit further includes:
a second circulation driving element that drives the fourth element; and
a second circulation wiring line that connects the fourth element and the second circulation driving element,
the first circulation driving element and the second circulation driving element are arranged symmetrically with respect to the boundary line, and
the first circulation wiring line and the second circulation wiring line are arranged symmetrically with respect to the boundary line.

6. The printing element substrate according to claim 5, wherein the first element is arranged closer to the first ejection driving element and the first circulation driving element than the second element.

7. The printing element substrate according to claim 4, further comprising
a first supply port that supplies a liquid to both a first channel and a second channel, the first channel supplying the liquid to the first element and the second element, the second channel supplying the liquid to the third element and the fourth element, wherein
the first supply port is provided between the first ejection wiring line and the second ejection wiring line in a first direction that intersects the boundary line.

8. The printing element substrate according to claim 7, wherein a plurality of first supply ports are provided in the first direction, the first supply ports each being the first supply port.

9. The printing element substrate according to claim 8, wherein
the first supply port is provided extending over the first unit and the second unit, and
the first supply port is positioned at a center of a region that includes the first unit and the second unit.

10. The printing element substrate according to claim 5, wherein
the first circulation wiring line is not provided between the second element and the fourth element, and
the first ejection wiring line is not provided between the first element and the third element.

11. The printing element substrate according to claim 7, further comprising:
a third unit including a fifth element and a sixth element;
a fourth unit including a seventh element and an eighth element; and
a second power supply wiring line including a third portion and a fourth portion, the third portion supplying electric power to the third unit, the fourth portion supplying electric power to the fourth unit, wherein
the second power supply wiring line includes a second extension portion that extends along a second boundary line between the third unit and the fourth unit,
the fifth element and the seventh element are arranged symmetrically with respect to the second extension portion,
the sixth element and the eighth element are arranged symmetrically with respect to the second extension portion, and
a unit including the first unit and the second unit and a unit including the third unit and the fourth unit are arranged symmetrically with respect to a third boundary line between the second unit and the third unit.

12. The printing element substrate according to claim 11, wherein
the fifth element and the seventh element are ejection elements for ejecting a liquid, and
the sixth element and the eighth element are circulation elements for circulating the liquid.

13. The printing element substrate according to claim 11, wherein a plurality of first supply ports are provided in the first direction, the first supply ports each being the first supply port.

14. The printing element substrate according to claim 7, further comprising:
a third unit including a fifth element and a sixth element;
a fourth unit including a seventh element and an eighth element; and
a second power supply wiring line including a third portion and a fourth portion, the third portion supplying electric power to the third unit, the fourth portion supplying electric power to the fourth unit, wherein
the second power supply wiring line includes a second extension portion that extends along a second boundary line between the third unit and the fourth unit,
the fifth element and the seventh element are arranged symmetrically with respect to the second extension portion,
the sixth element and the eighth element are arranged symmetrically with respect to the second extension portion,
the third portion and the fourth portion are arranged symmetrically with respect to the second extension portion, and
a fifth unit and a sixth unit are arranged symmetrically with respect to a predetermined point, the fifth unit including the first unit and the second unit, the sixth unit including the third unit and the fourth unit.

15. The printing element substrate according to claim 14, wherein two units each including the first unit, the second unit, the third unit, and the fourth unit are arranged symmetrically with respect to a predetermined point.

16. The printing element substrate according to claim 14, wherein
the printing element substrate further includes a second supply port that supplies a liquid to both the first channel on which the first element and the second element are arranged and the second channel on which the third element and the fourth element are arranged, the second supply port being different from the first supply port, and
the first element and the second element are arranged between the first supply port and the second supply port in a direction in which the boundary line extends.

17. The printing element substrate according to claim 16, wherein a plurality of second supply ports are provided in the first direction, the second supply ports each being the second supply port.

18. The printing element substrate according to claim 1, further comprising an ejection port forming member including an ejection port that is formed in the ejection port forming member and from which a liquid is ejected by driving of the first element and the third element.

19. The printing element substrate according to claim 1, wherein
a material constituting the printing element substrate includes:
a first layer including a metal; and
a second layer including a metal.

20. The printing element substrate according to claim 19, wherein at least one of the first layer and the second layer includes aluminum.

21. The printing element substrate according to claim 19, wherein at least one of the first layer and the second layer includes copper.

22. The printing element substrate according to claim 15, further comprising
an electric power supply wiring line for supplying electric power to the power supply wiring line, wherein
the power supply wiring line is provided in the first layer, and
the electric power supply wiring line is provided in the second layer.

23. A liquid ejection head, comprising:
a printing element substrate that includes a first unit, a second unit, and a power supply wiring line including a first portion and a second portion, the first unit including a first element and a second element, the second unit including a third element and a fourth element, the first portion supplying electric power to the first unit, the second portion supplying electric power to the second unit; and
a tank that stores a liquid to be supplied to the printing element substrate,
wherein the power supply wiring line includes an extension portion that extends along a boundary line between the first unit and the second unit,
the first element and the third element are arranged symmetrically with respect to the extension portion,
the second element and the fourth element are arranged symmetrically with respect to the extension portion, and
the first portion and the second portion are arranged symmetrically with respect to the extension portion.

24. A liquid ejection apparatus, comprising:
a printing element substrate that includes a first unit, a second unit, and a power supply wiring line including a first portion and a second portion, the first unit including a first element and a second element, the second unit including a third element and a fourth element, the first portion supplying electric power to the first unit, the second portion supplying electric power to the second unit; and
a tank that stores a liquid to be supplied to the printing element substrate; and
conveying unit for conveying a print medium,
wherein the power supply wiring line includes an extension portion that extends along a boundary line between the first unit and the second unit,
the first element and the third element are arranged symmetrically with respect to the extension portion,
the second element and the fourth element are arranged symmetrically with respect to the extension portion, and
the first portion and the second portion are arranged symmetrically with respect to the extension portion.
